(19) United States
(12) Patent Application Publication
(10) Pub. No.: US 2023/0267313 A1
(43) Pub. Date: Aug. 24, 2023

(54) ELECTRONIC DEVICE FOR PERFORMING CONVOLUTION CALCULATION AND OPERATION METHOD THEREFOR

(71) Applicant: SAMSUNG ELECTRONICS CO., LTD., Suwon-si (KR)

(72) Inventors: Minho KIM, Suwon-si (KR); Wooseok KANG, Suwon-si (KR); Eunkyoung PARK, Suwon-si (KR)

(73) Assignee: SAMSUNG ELECTRONICS CO., LTD., Suwon-si (KR)

(21) Appl. No.: 18/142,170

(22) Filed: May 2, 2023

Related U.S. Application Data
(63) Continuation of application No. PCT/KR2021/015706, filed on Nov. 2, 2021.

(30) Foreign Application Priority Data
Nov. 5, 2020 (KR) 10-2020-0147081

(51) Int. Cl. G06N 3/047

(52) U.S. Cl. CPC G06N 3/047

(57) ABSTRACT

An electronic device and method thereof. The electronic device includes an input feature map transformer configured to transform an input feature map (IFM) to a Winograd domain, a weight kernel transformer configured to transform a weight kernel to the Winograd domain, a transformation data processor configured to map, a plurality of types of multiply-accumulate (MAC) units included in a computation unit, to a plurality of feature groups grouping feature values in a plurality of channels of the transformed input feature map and a plurality of weight value groups grouping weight values in a plurality of channels of the transformed weight kernel, a computation data processor configured to collect MAC operation results from the computation unit, and an inverse transformer configured to perform an inverse Winograd transform on a result output from the computation data processor to thereby generate an output feature map (OFM) useable for performing a convolution operation.

### TECHNICAL FIELD

The present disclosure relates to an electronic device for performing neural network computation, and more particularly, to an electronic device for performing a neural network convolution operation based on a Winograd transform and an operating method of the electronic device.

### BACKGROUND ART

With the development of neural network technology, research has been actively conducted on a technique of extracting valid information from input data by performing neural network convolution operations in various types of systems. Recently, there have been discussions regarding techniques that enable an electronic device to directly perform a convolution operation in a neural network by using edge computing technology. As a convolution operation occupies a significant part of computations required in a neural network model, a neural network model for performing a convolution operation in an electronic device and extracting information needs to be lightweight, and an electronic device capable of efficiently processing the convolution operation in the lightweight neural network model is required.

### DISCLOSURE

### Technical Problem

Various embodiments are to provide an electronic device and operation method thereof for transforming pieces of data to a Winograd domain and performing convolution operations using different types of low-precision multiply-accumulate (MAC) units according to statistical characteristics of the transformed pieces of data.

### Technical Solution

According to an aspect of the present disclosure, an electronic device for performing a convolution operation may be provided. The electronic device may be a device including an input feature map transformer configured to transform an input feature map (IFM) to a Winograd domain, a weight kernel transformer configured to transform a weight kernel to the Winograd domain, a transformation data processor configured to map, a plurality of types of multiply-accumulate (MAC) units included in a computation unit, to a plurality of feature groups created by grouping feature values in a plurality of channels of the transformed input feature map and a plurality of weight value groups created by grouping weight values in a plurality of channels of the transformed weight kernel, the plurality of types of MAC units being configured to perform a MAC operation between a weight value group of the plurality of weight value groups and a feature value group of the plurality of feature groups, a computation data processor configured to collect MAC operation results from the computation unit, and an inverse transformer configured to perform an inverse Winograd transform on a result output according to the collected MAC operation results from the computation data processor to thereby generate an output feature map (OFM) useable for performing a convolution operation.

The computation may include at least one type of MAC unit from among a first type MAC unit, a second type MAC unit, and a third type MAC unit included in the plurality of types of MAC units, and the transformation data processor may map the plurality of feature value groups and the plurality of weight value groups to the at least one type of MAC unit from among the first type MAC unit, the second type MAC unit, and the third type MAC unit included in the plurality of types of MAC units.

The transformation data processor may map, based on a pre-generated mapping table, the plurality of feature value groups and the plurality of weight value groups to the at least one type of MAC unit from among the first type MAC unit, the second type MAC unit, and the third type MAC unit included in the plurality of types of MAC units.

The pre-generated mapping table may be generated to map the plurality of feature value groups and the plurality of weight value groups to corresponding types of MAC units to perform MAC operations, based on a frequency distribution calculated for each of the plurality of feature value groups and a frequency distribution calculated for each of the plurality of weight value groups.

The pre-generated mapping table may be generated to map the plurality of feature value groups and the plurality of weight value groups to corresponding types of MAC units to perform MAC operations, based on at least one of an input feature map sensitivity matrix representing statistical characteristics of the transformed input feature map, a weight kernel sensitivity matrix representing statistical characteristics of the transformed weight kernel, and an output feature map sensitivity matrix representing statistical characteristics of the output feature map.

The first type MAC unit may include a plurality of multiplier units, and an accumulator configured to accumulate and add outputs respectively from the plurality of multiplier units, and each of the plurality of multiplier units may include a first shifter configured to receive a first fixed-point number and perform a right shift operation, a second shifter configured to receive a second fixed-point number and perform a right shift operation, a multiplier configured to receive an output of the first shifter and an output of the second shifter and perform a multiplication operation between the output of the first shifter and the output of the second shifter, and a restoration shifter configured to receive an output of the multiplier and restore a bit length by performing a left shift operation on the output of the multiplier.

The first shifter included in each of the plurality of multiplier units of the first type MAC unit may, when a bit length of the first fixed-point number exceeds a preset first bit length, reduce the bit length of the first fixed-point number by shifting the first fixed-point number to the right by a bit length in excess of the preset first bit length, the second shifter included in each of the plurality of multiplier units of the first type MAC unit may, when a bit length of the second fixed-point number exceeds a preset second bit length, reduce the bit length of the second fixed-point number by shifting the second fixed-point number to the right by a bit length in excess of the preset second bit length, and the restoration shifter included in each of the plurality of multiplier units of the first type MAC unit may restore the bit length of the first fixed-point number by shifting the output of the multiplier to the left by a sum of the bit length of the first fixed-point number by which the first shifter shifts the first fixed-point number to the right and the bit length of the second fixed-point number by which the second shifter shifts the second fixed-point number to the right.

The first fixed-point number input to the first shifter of the first type MAC unit and the second fixed-point number input to the second shifter of the first type MAC unit may be input by exchanging, based on a value of the first fixed-point number, the first bit length, a value of the second fixed-point number, and the second bit length, the value of the first fixed-point number and the value of the second fixed-point number.

The second type MAC unit may include a plurality of multiplier units, an accumulator configured to accumulate and add outputs respectively from the plurality of multiplier units, and a restoration shifter configured to receive an output of the accumulator and restore a bit length by performing a left shift operation on the output of the accumulator, and each of the plurality of multiplier units may include a first shifter configured to receive a first fixed-point number and perform a right shift operation, a second shifter configured to receive a second fixed-point number and perform a right shift operation, a multiplier configured to receive an output of the first shifter and an output of the second shifter and perform a multiplication operation between the output of the first shifter and the output of the second shift, and a first restoration shifter configured to receive an output of the multiplier and increase a bit length by performing a left shift operation on the output of the multiplier.

The first shifter included in each of the plurality of multiplier units of the second type MAC unit may reduce a bit length of the first fixed-point number by shifting the first fixed-point number to the right by a preset first bit length, the second shifter included in each of the plurality of multiplier units of the second type MAC unit may, when a bit length of the second fixed-point number exceeds a preset second bit length, reduce the bit length of the second fixed-point number by shifting the second fixed-point number to the right by a bit length in excess of the second bit length of the second fixed-point number, the restoration shifter included in each of the plurality of multiplier units of the second type MAC unit may increase the bit length of the second fixed-point number by shifting the output of the multiplier to the left by the bit length of the second fixed-point number by which the second shifter shifts the second fixed-point number to the right, and the second restoration shifter of the second type MAC unit may restore the bit length of the first fixed-point number by shifting the output of the accumulator of the second type MAC unit to the left by the first bit length of the first fixed-point number.

The preset first bit length may be determined for each of the plurality of weight value groups, based on a maximum value and a minimum value of weight values included in each of the plurality of weight value groups.

The third type MAC unit may include a plurality of multiplier units, an accumulator configured to accumulate and add outputs respectively from the plurality of multiplier units, and a restoration shifter configured to receive an output of the accumulator and restore a bit length by performing a left shift operation, and each of the plurality of multiplier units may include a first shifter configured to receive a first fixed-point number and perform a right shift operation, a second shifter configured to receive a second fixed-point number and perform a right shift operation, and a multiplier configured to receive an output of the first shifter and an output of the second shifter and perform a multiplication operation between the output of the first shifter and the output of the second shifter.

The first shifter included in each of the plurality of multiplier units of the third type MAC unit may reduce a bit length of the first fixed-point number by shifting the first fixed-point number to the right by a preset first bit length, the second shifter included in each of the plurality of multiplier units of the third type MAC unit may reduce a bit length of the second fixed-point number by shifting the second fixed-point number to the right by a preset second bit length, and the restoration shifter of the third type MAC unit may restore the bit length by shifting the output of the accumulator to the left by a sum of the first bit length and the second bit length.

The preset first bit length may be determined for each of the plurality of weight value groups, based on a maximum value and a minimum value of weight values included in each of the plurality of weight value groups, and the preset second bit length may be determined for each of the plurality of feature value groups, based on a maximum value and a minimum value of feature values included in each of the plurality of feature value groups.

The preset first bit length may be determined for each of the plurality of weight value groups, based on a preset maximum threshold and a preset minimum threshold of weight values included in each of the plurality of weight value groups, and the preset second bit length may be determined for each of the plurality of feature value groups, based on a maximum value and a minimum value of feature values included in each of the plurality of feature value groups.

According to an aspect of the present disclosure, an operation method of an electronic device for performing a convolution operation may be provided. The operation method may include transforming an input feature map (IFM) to a Winograd domain, transforming a weight kernel to the Winograd domain, creating a plurality of feature value groups by grouping feature values at same coordinates in a plurality of channels of the transformed input feature map, creating a plurality of weight value groups by grouping weight values at same coordinates in a plurality of channels of the transformed weight kernel, mapping the plurality of feature value groups and the plurality of weight value groups to a plurality of types of MAC units included in the electronic device, outputting a MAC operation value by performing, a MAC operation, for the plurality of feature value groups with the plurality of weight value groups, respectively; generating a transformed output feature map by collecting MAC operation results according to the outputting of the output MAC operation value, and performing an inverse Winograd transform on the generated transformed output feature map to thereby generate an output feature map (OFM) useable for performing a convolution operation.

According to an aspect of the present disclosure, a non-transitory computer-readable recording medium having recorded thereon a program to execute a method, performed by an electronic device, of performing a convolution operation may be provided. The method stored in the computer-readable recording medium may include transforming an input feature map (IFM) to a Winograd domain, transforming a weight kernel to the Winograd domain, creating a plurality of feature value groups by grouping feature values at the same coordinates in a plurality of channels of the transformed input feature map, creating a plurality of weight value groups by grouping weight values at the same coordinates in a plurality of channels of the transformed weight kernel, mapping the plurality of feature value groups and the plurality of weight value groups to a plurality of types of MAC units included in the electronic device, outputting a MAC operation value by performing, for each of the plurality of feature value groups, a MAC operation with each of a plurality of weight value groups, generating a transformed output feature map by collecting the output MAC operation value, and generating an output feature map by performing an inverse Winograd transform on the generated transformed output feature map to thereby generate an output feature map (OFM) useable for performing a convolution operation.

### DESCRIPTION OF DRAWINGS

The above and other aspects, features, and advantages of specific embodiments of the present disclosure will be more apparent from the following description taken in conjunction with the accompanying drawings.

FIG. 1 is a diagram for explaining an electronic device for performing a convolution operation and an operation of the electronic device, according to an embodiment.

FIG. 2 is a diagram for explaining a concept of a convolution operation based on a Winograd transform according to an example.

FIGS. 3A to 3F are diagrams referenced to describe a configuration and an operation of an electronic device according to an embodiment.

FIG. 4 is a diagram referenced to further describe operations performed by an electronic device in a Winograd domain, according to an embodiment.

FIGS. 5A to 5F are diagrams referenced to describe an operation in which a transformation data processor included in an electronic device performs mapping to a plurality of types of multiply-accumulate (MAC) units based on a mapping table, according to an embodiment.

FIG. 6 is a diagram referenced to describe a method of quantizing values input to an electronic device, according to an embodiment.

FIGS. 7A to 7C are diagrams referenced to describe a first type MAC unit among a plurality of types of MAC units for performing MAC operations between a weight value group and a feature value group.

FIGS. 8A and 8B are diagrams referenced to describe a second type MAC unit among a plurality of types of MAC units for performing MAC operations between a weight value group and a feature value group.

FIGS. 9A and 9B are diagrams referenced to describe a third type MAC unit among a plurality of types of MAC units for performing MAC operations between a weight value group and a feature value group.

FIG. 10 is a diagram referenced to describe a fourth type MAC unit among a plurality of types of MAC units for performing MAC operations between weight values and feature values.

FIG. 11 is a diagram for explaining a method, performed by a statistical characteristics analyzer, of analyzing statistical characteristics of weight value groups and feature value groups, according to an embodiment.

### MODE FOR INVENTION

Terms used in the present specification will now be briefly described and then an embodiment of the present disclosure will be described in detail.

The terms used in the present specification may be general terms currently widely used in the art based on functions described in the present disclosure, but may be changed according to an intention of a technician engaged in the art, precedent cases, advent of new technologies, etc. Furthermore, some particular terms may be arbitrarily selected by the applicant, and in this case, the meaning of the selected terms will be described in detail in the detailed description of the disclosure. Thus, the terms used herein should be defined not by simple appellations thereof but based on the meaning of the terms together with the overall description of the present disclosure.

Throughout the specification, when a part “includes” or “comprises” an element, unless there is a particular description contrary thereto, it is understood that the part may further include other elements, not excluding the other elements. Furthermore, terms such as “portion,” “module,” etc. used herein indicate a unit for processing at least one function or operation and may be implemented as hardware or software or a combination of hardware and software.

Embodiments of the present disclosure will be described more fully hereinafter with reference to the accompanying drawings so that they may be easily implemented by one of ordinary skill in the art. However, the present disclosure may be implemented in different forms and should not be construed as being limited to the embodiments set forth herein. In addition, parts not related to descriptions of the present disclosure are omitted to clearly explain the present disclosure in the drawings, and like reference numerals denote like elements throughout.

Methods by which a shifter shifts input values to the right according to the disclosed embodiments may include two types of shifting methods.

A first shifting method refers to a shifting method for, when a bit length of input data exceeds a preset bit length, reducing the bit length by shifting the input data to the right by a bit length in excess of the preset bit length.

A second shifting method refers to a shifting method for, regardless of a bit length of input data, reducing the bit length by shifting the input data to the right by a preset bit length.

Data having a bit length reduced by shifting the data to the right using the first shifting method or the second shifting method may be processed into data having a bit length restored by shifting, via a restoration shifter, the data to the left by the number of bits by which the original bit length is reduced.

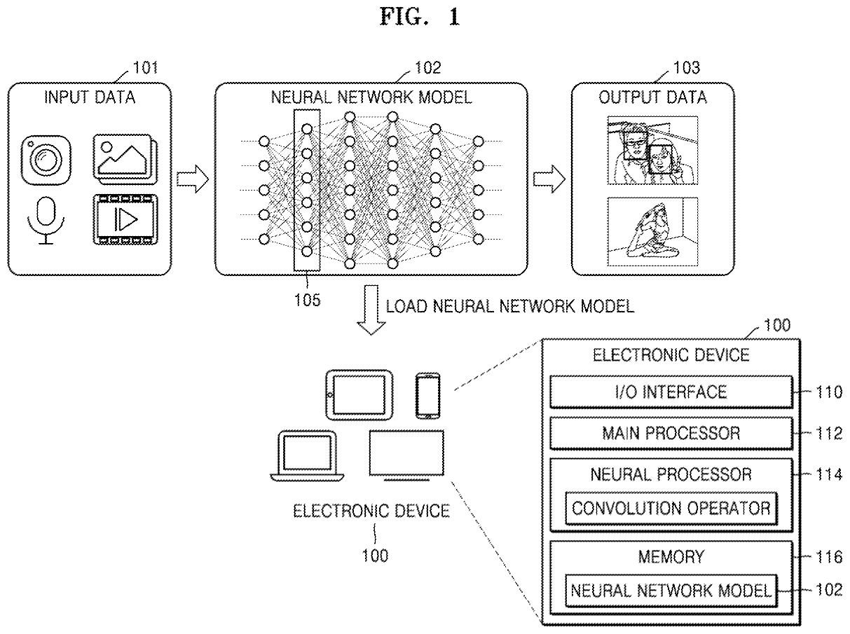

FIG. 1 is a diagram for explaining an electronic device for performing a convolution operation and an operation of the electronic device, according to an embodiment.

Referring to FIG. 1, an electronic device 100 may receive input data 101, perform computations using a neural network model 102 loaded in the electronic device, and obtain output data 103 representing inference results, etc. According to an embodiment, examples of the electronic device may include, but are not limited to, electronic devices such as smartphones, smart TVs, smart home appliances, mobile devices, image display devices, desktop computers, drones, etc., and the electronic device may be any of various edge devices capable of performing edge computing.

According to an embodiment, the electronic device 100 may include at least an input/output (I/O) interface 110, a main processor 112, a neural processor 114, and a memory 116.

In an embodiment, the I/O interface 110, the main processor 112, the neural processor 114, and the memory 116 included in the electronic device 100 may be implemented as a single semiconductor chip, e.g., as a system on chip (SoC). However, the present disclosure is not limited thereto, and components of the electronic device 100 may be composed of a plurality of semiconductor chips.

The I/O interface 110 may receive input data via user input or from the outside, and may output a result of data processing by the electronic device 100. For example, the I/O interface may include a camera, a display, a touch screen panel, a keyboard, a plurality of sensors, etc. The plurality of sensors may include, for example, an image sensor, a light detection and ranging (LiDAR) sensor, an ultrasonic sensor, an infrared sensor, etc, but are not limited thereto. The I/O interface 110 may receive data (e.g., image data) from the outside of the electronic device 100, store the received data in the memory 116, or provide the received data to the main processor 112 or the neural processor 114. In addition, the I/O interface 110 may further include a communication interface for transmitting and receiving data from the outside.

The main processor 112 may perform all operations of the electronic device 100. The main processor 112 may execute one or more instructions of a program stored in a memory or a plurality of neural network models. According to an embodiment, the main processor 112 may be, but is not limited to, a central processing unit (CPU), and may include an application processor (AP), a graphics processing unit (GPU), etc.

The neural processor 114 may be a dedicated artificial intelligence (AI) processor or the like designed as a hardware structure specialized for processing a neural network model. The neural processor 114 may generate a neural network model, train the neural network model, or perform computation based on received input data by using the neural network model and generate output data. For example, the neural network model may include, but is not limited to, various types of neural network models, such as a convolutional neural network (CNN), a deep neural network (DNN), a recurrent neural network (RNN), a restricted Boltzmann machine (RBM), a deep belief network (DBN), a bidirectional recurrent DNN (BRDNN), or deep Q-networks (DQN). A neural network model 102 may be downloaded to the electronic device 100 from the outside and stored in the memory 116 of the electronic device. Furthermore, the neural network model 102 stored in the memory 116 may be updated.

The memory 116 may store various pieces of data, programs, or applications for operating and controlling the electronic device 100. A program stored in memory 116 may include one or more instructions. A program (one or more instructions) or application stored in memory 116 may be executed by the main processor 112. According to an embodiment, the memory 116 may include at least one type of storage medium among a flash memory-type memory, a hard disk-type memory, a multimedia card micro-type memory, a card-type memory (e.g., an SD card or an XD memory), random access memory (RAM), static RAM (SRAM), read-only memory (ROM), electrically erasable programmable ROM (EEPROM), PROM, a magnetic memory, a magnetic disk, and an optical disk.

The electronic device 100 may execute the neural network model 102 stored in the memory 116 and perform a convolution operation in the neural network model 102 by using the neural processor 114. In this case, the neural network model 102 may include a plurality of layers. The electronic device 100 may receive input data 101 and perform convolution operations in the plurality of layers included in the neural network model 102 to thereby obtain output data 103.

The neural processor 114 may include a convolution operator capable of performing convolution operations respectively performed in a plurality of layers included in the neural network model 102. In this case, the convolution operator may be configured to include, for example, a computational circuit including a plurality of multiplier-accumulators. In each layer 105 of the plurality of layers included in the neural network model 102, the neural processor 114 may receive data output from a previous layer, perform a convolution operation thereon, and output a result to a next layer. However, the present disclosure is not limited thereto, and convolution operations performed by the neural processor 114 may also be performed by another hardware device (e.g., a CPU, a GPU, or an application-specific integrated circuit (ASIC)) capable of performing convolution operations.

The electronic device 100 according to the disclosed embodiment may be a type of edge device capable of performing edge computing. However, the present disclosure is not limited thereto, and the electronic device may include hardware capable of performing convolution operations to execute a neural network model and process data.

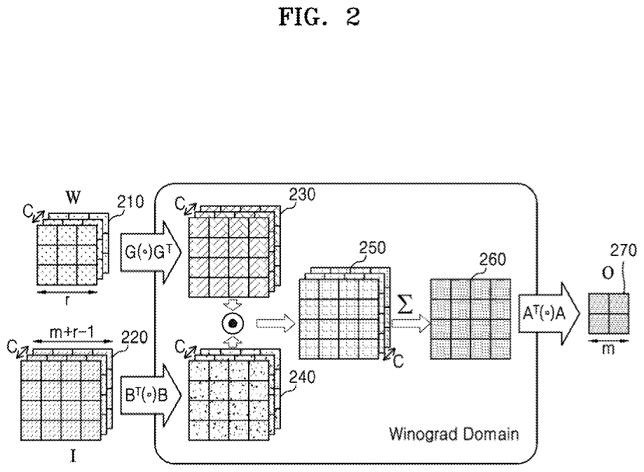

FIG. 2 is a diagram for explaining a concept of a convolution operation based on a Winograd transform according to an example.

Referring to FIG. 2, a convolution operation based on a Winograd transform according to an example may include transforming an input feature map IFM 220 and a weight kernel WK 210 to a Winograd domain and performing element-wise multiplications and accumulations therebetween to obtain an output feature map OFM 270.

In this case, the output feature map OFM 270 generated as a result of the convolution operation may have a size of m×m. Also, the weight kernel WK 210 may include a plurality of channels and have a size of r×r. Also, the input feature map IFM 220 may include a plurality of channels and may have a size of (m+r−1)×(m+r−1). Also, the number of the plurality of channels in each of the input feature map IFM 220 and the weight kernel WK 210 is equal.

As the Winograd transform is performed on each of the input feature map IFM 220 and the weight kernel WK 210, an input feature map 240 transformed to the Winograd domain and a weight kernel 230 transformed to the Winograd domain may be generated.

In addition, as a result of performing element-wise multiplications ⊙ between the transformed input feature map 240 and the transformed weight kernel 230, a plurality of output matrices 250 having a matrix structure in which the element-wise multiplications ⊙ have been performed for each channel may be obtained, and the plurality of output matrices 250 may be added together to obtain a transformed output feature map 260.

Furthermore, an output feature map OFM 270 may be obtained by performing an inverse Winograd transform on the transformed output feature map 260.

For convenience of description, the Winograd transform convolution is described in detail below by taking as an example an embodiment in which the weight kernel WK 210 has a size of 3×3, the output feature map OFM 270 has a size of 2×2, and the plurality of channels are 3 channels.

Referring back to FIG. 2, when the weight kernel WK 210 has a 3×3 matrix structure and includes 3 channels, and the input feature map IFM 220 has a 4×4 matrix structure and includes 3 channels, the Winograd transform may be performed on the weight kernel WK 210 and the input feature map IFM 220 by the electronic device to respectively generate the transformed weight kernel 230 and the transformed input feature map 240, both of which have a 4×4 matrix structure and include three channels.

When element-wise multiplications ⊙ are performed on the transformed input feature map 240 and the transformed weight kernel 230 in the Winograd domain, the output matrices 250 having a 4×4 matrix structure for the three channels may be output, and operation results may be added element-wise to obtain the transformed output feature map 260 having a 4×4 matrix structure. In addition, the output feature map 270 having a 2×2 matrix structure may be obtained by performing an inverse Winograd transform on the transformed output feature map 260.

In the convolution operation based on the Winograd transform according to the example, which includes performing element-wise multiplications in the Winograd domain and performing an inverse Winograd transform to obtain an output feature map, the output feature map may be obtained with a reduced number of multiplication operations compared to when performing a convolution operation in a spatial domain while achieving the same result as in the convolution operation in the spatial domain.

The electronic device according to the disclosed embodiment may be designed with a structure suitable for performing the above-described Winograd-based convolution operation. In detail, the Winograd-based convolution operation may be performed by transforming pieces of data to the Winograd domain, grouping pieces of data transformed to the Winograd domain, and performing multiply-accumulate (MAC) operations by mapping the grouped pieces of data to a plurality of types of MAC units.

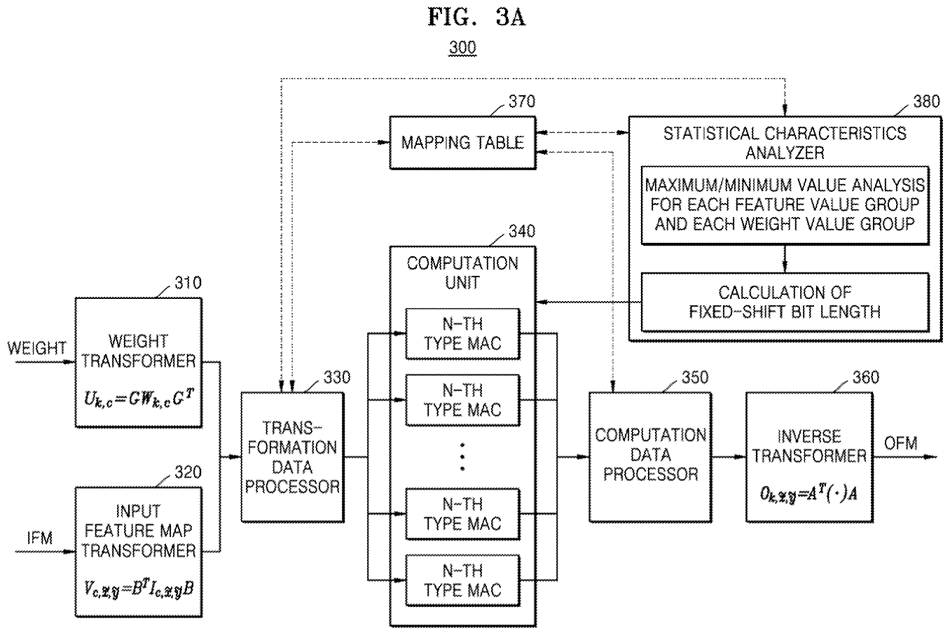

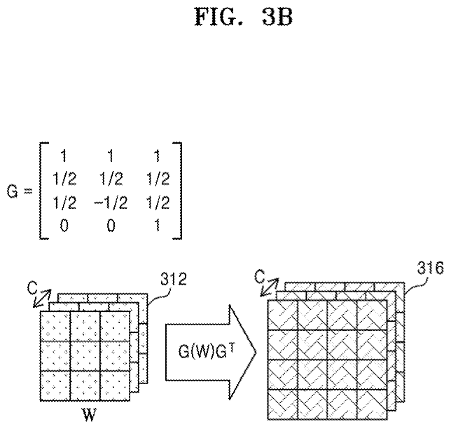

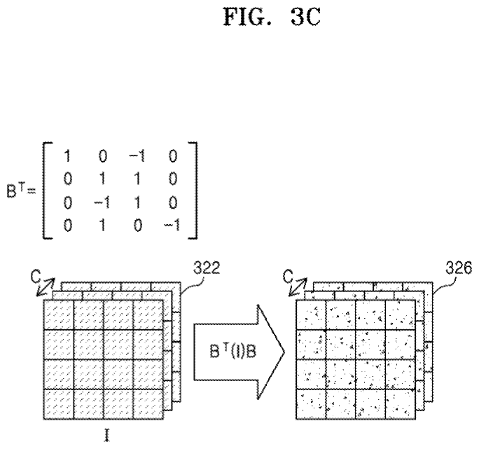

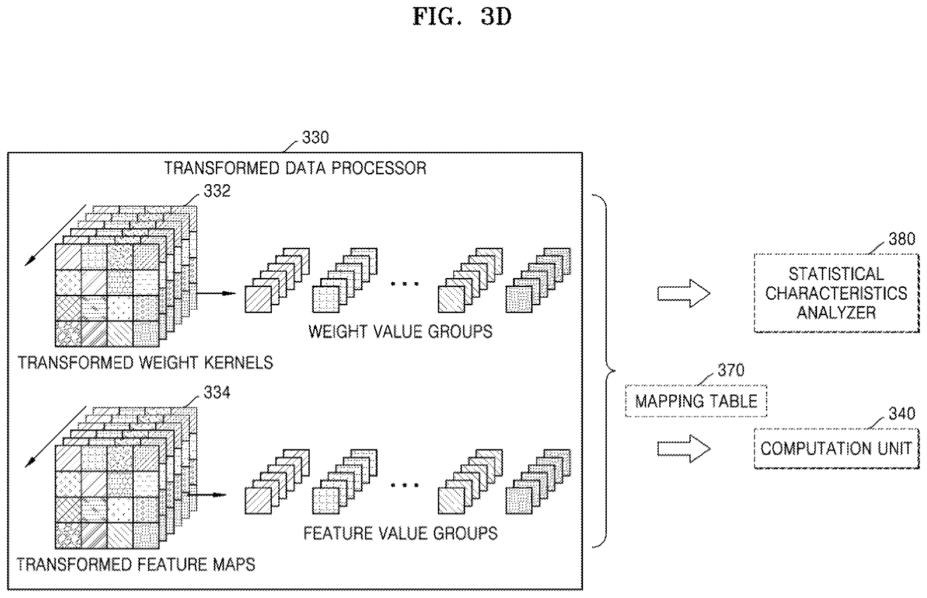

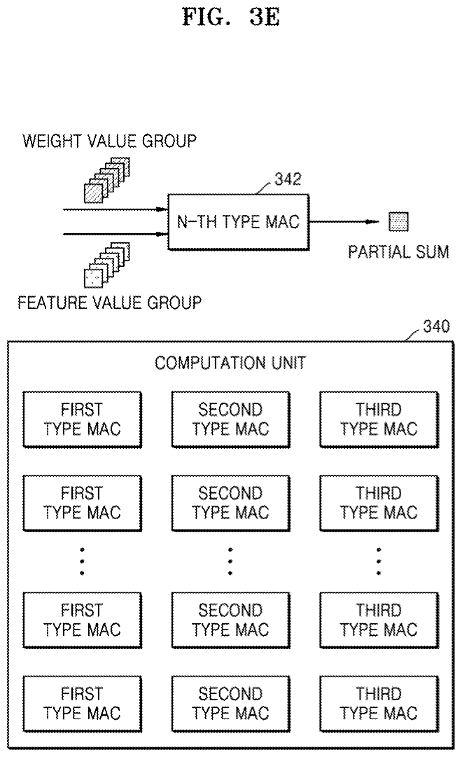

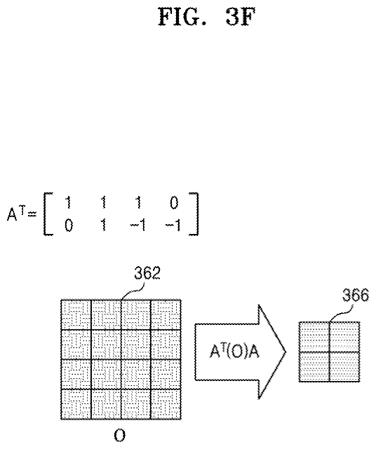

FIGS. 3A to 3F are diagrams referenced to describe a configuration and an operation of an electronic device that performs a convolution operation, according to an embodiment.

Referring to FIG. 3A, an electronic device 300 may include at least a weight transformer 310, an input feature map transformer 320, a transformation data processor 330, a computation unit 340, a computation data processor 350, and an inverse transformer 360. In addition, the electronic device 300 may further include a statistical characteristics analyzer 380, but is not limited thereto, and the statistical characteristics analyzer 380 may be a separate module located outside the electronic device 300.

According to an embodiment, the weight transformer 310 may receive weight kernels comprising of a plurality of channels, and perform a Winograd transform operation thereon to generate transformed weight kernels, each having a matrix structure and including a plurality of channels.

For example, referring to FIG. 3B, when a weight kernel has a size of 3×3, the weight transformer 310 may receive weight kernels 312 including a plurality of channels, each channel having a 3×3 matrix structure, and perform a multiplication operation on each of the weight kernels 312 by using a Winograd transform matrix and a transpose matrix to thereby generate transformed weight kernels 316. However, the present disclosure is not limited to the above example, and the weight transformer 310 may receive a weight kernel of various dimensions and perform a Winograd transform thereon to generate a transformed weight kernel. According to an example, the weight transformer 310 may include a plurality of circuit elements for generating such transformed weight kernels.

Referring back to FIG. 3A, according to an embodiment, the input feature map transformer 320 may receive input feature maps including a plurality of channels and perform a Winograd transform operation to thereby generate transformed input feature maps having a matrix structure and including a plurality of channels.

For example, referring to FIG. 3C, when an input feature map has a size of 4×4, the input feature map transformer 320 may receive input feature maps 322 including a plurality of channels, each channel having a 4×4 matrix structure, and perform a multiplication operation on each of the input feature maps 322 by using a Winograd transform matrix and a transpose matrix to thereby generate transformed input feature maps 326. However, the present disclosure is not limited to the above example, and the input feature map transformer 320 may receive input feature maps of various dimensions and perform Winograd transforms thereon to generate transformed input feature maps. According to an example, the input feature map transformer 320 may include a plurality of circuit elements for generating such transformed input feature maps. Referring back to FIG. 3A, according to an embodiment, the transformation data processor 330 may be connected to the weight transformer 310 and the input feature map transformer 320, and respectively receive the transformed weight kernels and the transformed input feature maps from the weight transformer 310 and the input feature map transformer 320.

The transformation data processor 330 may group weight values from a plurality of channels of the transformed weight kernels. For example, a plurality of weight values at the same matrix coordinates in a plurality of channels of the transformed weight kernels may be grouped so as to be reorganized into a plurality of weight value groups. Also, the transformation data processor 330 may group feature values from a plurality of channels of the transformed input feature maps. For example, feature values at the same matrix coordinates in a plurality of channels of transformed feature maps may be grouped so as to be reorganized into a plurality of feature value groups.

For example, referring to FIG. 3D, when transformed weight kernels 332 have a 4×4 matrix structure and consist of six channels, the transformation data processor 330 may group weight values at the same matrix coordinates in the six channels of the transformed weight kernels 332 to create first to sixteenth weight value groups. In addition, when transformed feature maps 334 have a 4×4 matrix structure and consist of 6 channels, the transformation data processor 330 may group feature values at the same matrix coordinates in the six channels of the transformed feature maps 334 to create first to sixteenth feature value groups.

According to an embodiment, by creating a plurality of weight value groups and a plurality of feature value groups, the transformation data processor 330 may output the plurality of weight value groups and the plurality of feature value groups to the statistical characteristics analyzer 380 in order to obtain statistical characteristics of values included in each of the groups. In addition, when element-wise MAC operations are performed on the created weight value groups and feature value groups, the transformation data processor 330 may assign each weight value group and each feature value group to a corresponding type of MAC unit based on a MAC unit mapping table, so that a MAC operation may be performed in a different way for each weight value group and each feature value group.

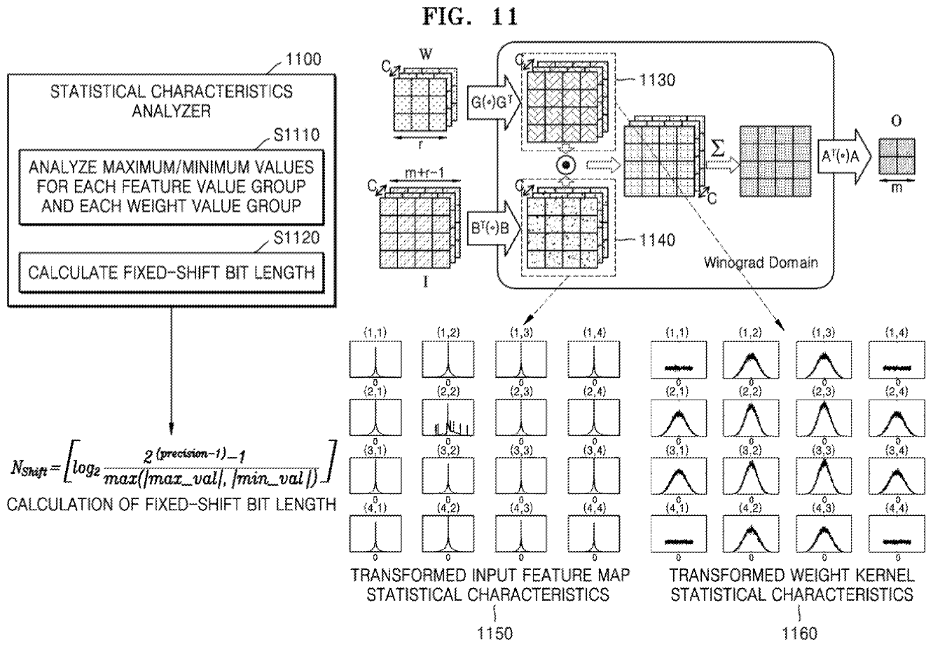

According to an embodiment, the transformation data processor 330 may output the plurality of weight value groups and the plurality of feature value groups to the statistical characteristics analyzer 380. The statistical characteristics analyzer 380 may analyze statistical characteristics of weight values included in each of the plurality of weight value groups and statistical characteristics of feature values included in each of the plurality of feature value groups. A method, performed by the statistical characteristics analyzer 380, of analyzing statistical characteristics of the weight value groups and the feature value groups is described in detail below in the description with respect to FIG. 11.

According to an embodiment, the transformation data processor 330 may output the plurality of weight value groups and the plurality of feature value groups to the computation unit 340. In this case, the transformation data processor 330 may output the plurality of weight value groups and the plurality of feature value groups by mapping, based on a mapping table 370, the plurality of weight value groups and the plurality of feature value groups to MAC units included in the computation unit 340. In this case, the mapping table 370 may be pre-generated. Also, according to an example, the transformation data processor 330 may consist of a plurality of circuit elements that receive pieces of data from the weight transformer 310 and the input feature map transformer 320 and output processing results to the computation unit 340.

Referring back to FIG. 3A, according to an embodiment, the computation unit 340 may be connected to the transformation data processor 330 and receive the plurality of weight value groups and the plurality of feature value groups from the transformation data processor 330.

The computation unit 340 may include a plurality of circuit elements for performing computations. In detail, according to the disclosed embodiment, the computation unit 340 may include a plurality of types of MAC units having different structures.

According to the disclosed embodiment, a weight value and a feature value transformed to the Winograd domain may have greater bit lengths than a weight value and a feature value not transformed to the Winograd domain. Therefore, in order to reduce the area of hardware performing computations, a bit length of a transformed feature value or a transformed weight value may need to be reduced by using various types of MAC units. In this case, elements in an input weight value group and elements in an input feature value group may be truncated to a reduced bit length when input to a multiplier and restored to the original bit length after undergoing a multiplication operation.

Each of a plurality of MAC units included in the computation unit 340 may be used to perform an MAC operation by multiplying and adding elements of a weight value group and elements of a feature value group.

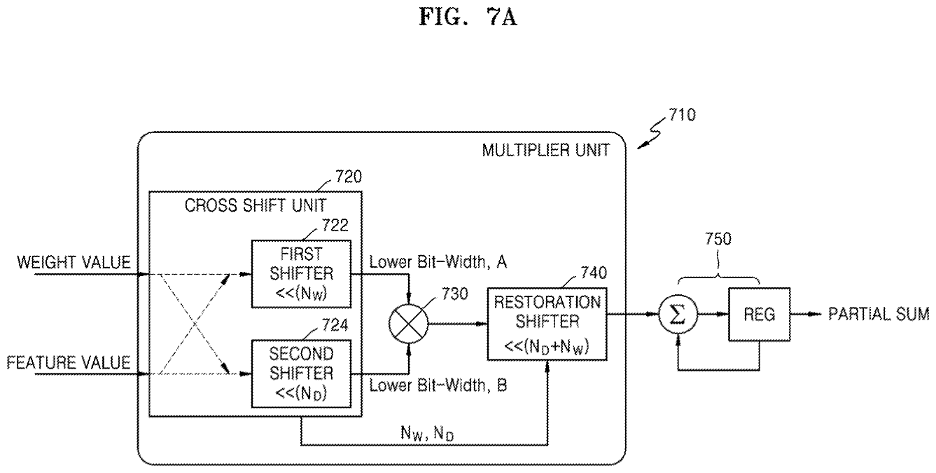

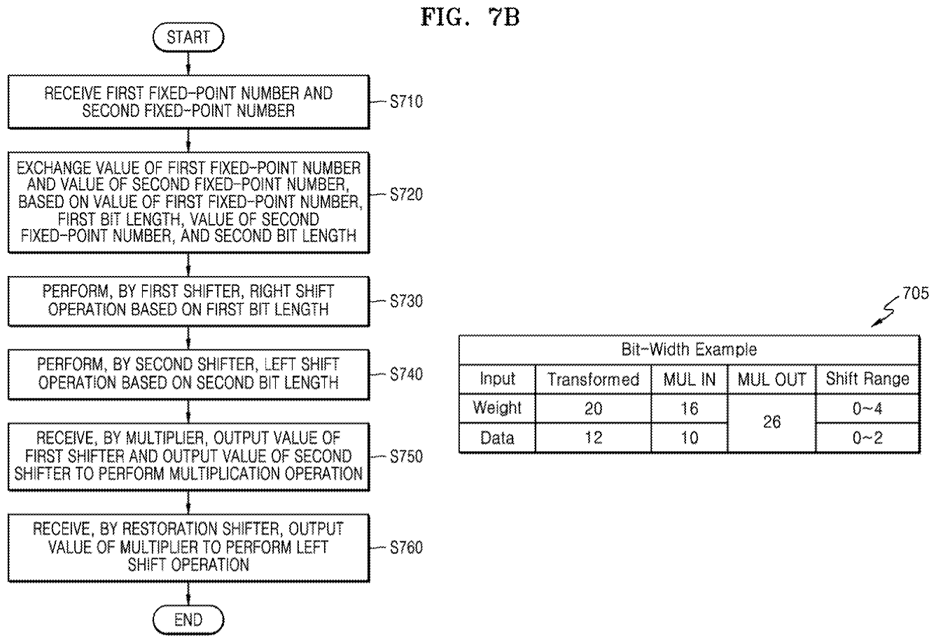

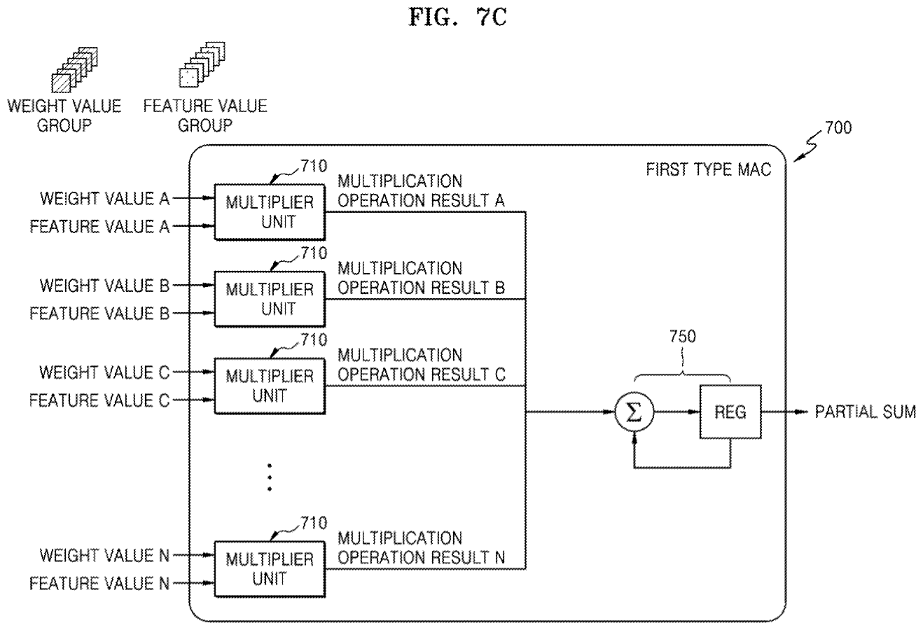

For example, referring to FIG. 3E, the computation unit 340 may include a first type MAC unit, a second type MAC unit, and a third type MAC unit. However, the present disclosure is not limited thereto, and the computation unit 340 may not include at least some types of MAC units from among the first type MAC unit to the third type MAC unit, and may further include other types of MAC units. Detailed structures of various types of MAC units included in the computation unit 340 are described in detail in the description with respect to FIGS. 7A to 10.

According to an embodiment, an N-th type MAC unit 342 (e.g., the first type MAC unit) included in the computation unit 340 may receive a weight value group and a feature value group as an input and then multiply an element in the weight value group by a corresponding element in the feature value group for each channel. The computation unit 340 may cumulatively add results of performing element-wise multiplication operations channel by channel to thereby output a partial sum that is a result of a MAC operation between the weight value group and the feature value group.

Referring back to FIG. 3A, according to an embodiment, the computation data processor 350 may be connected to the computation unit 340 and may receive partial sums that are MAC results calculated by the plurality of MAC units included in the computation unit.

The computation data processor 350 may generate a transformed output feature map by using MAC partial sums calculated by the plurality of MAC units. For example, the computation data processor 350 may collect partial sums that results of performing MAC operations between weight value groups and corresponding feature value groups, and reorganize the resulting values to have the same coordinates as before the weight value groups and the feature value groups are mapped to the computation unit 340. Therefore, the computation data processor 350 may generate a transformed output feature map having the same matrix structure as before the transformed input feature maps are input to the computation unit 340. According to an example, the computation data processor 350 may include a plurality of circuit elements that generate the transformed output feature map.

According to an embodiment, the inverse transformer 360 may be connected to the computation data processor 350 and receive the transformed output feature map generated by the computation data processor 350.

For example, referring to FIG. 3F, the inverse transformer 360 may receive a transformed output feature map 362 and perform a multiplication operation on the transformed output feature map 362 by using an inverse Winograd transform matrix and a transpose matrix to thereby generate an output feature map 366. According to an example, the inverse transformer 360 may consist of a plurality of circuit elements that generate the output feature map 366.

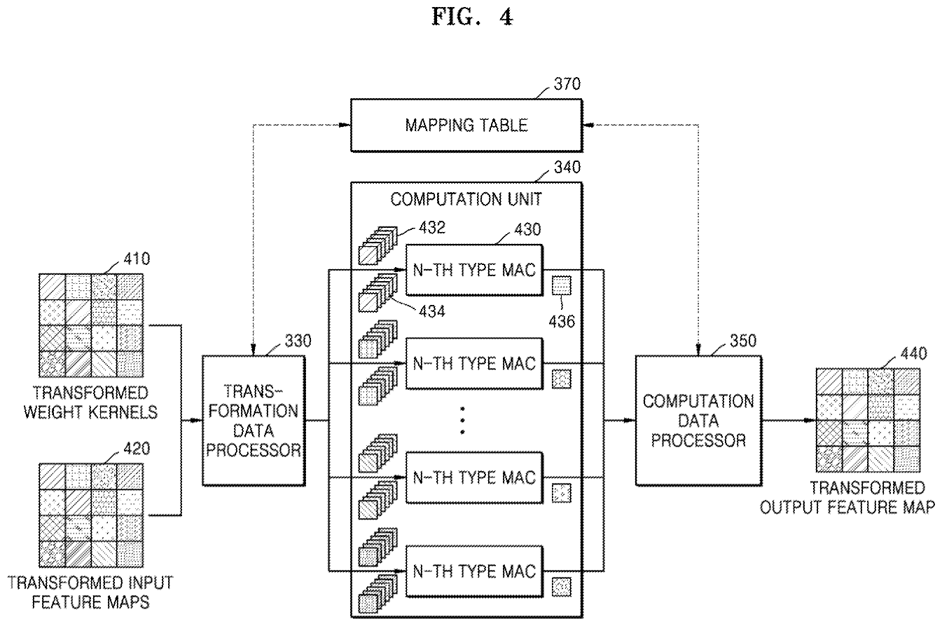

FIG. 4 is a diagram referenced to further describe operations performed by the electronic device 300 in a Winograd domain, according to an embodiment.

In describing FIG. 4, the same components as those in FIGS. 3A to 3F are described using the same reference numerals.

Referring to FIG. 4, according to an embodiment, the transformation data processor 330 may receive transformed weight kernels 410 to generate a plurality of weight value groups and receive transformed input feature maps 420 to generate a plurality of feature value groups. For example, when each of the transformed weight kernels 410 and each of the transformed input feature maps 420 have a 4×4 matrix structure, weight values at the same matrix coordinate values may be grouped to create sixteen weight value groups, and feature values at the same matrix coordinate values may be grouped to create sixteen feature value groups.

The transformation data processor 330 may map, based on the mapping table 370, the created plurality of weight value groups and the created plurality of feature value groups to a plurality of types of MAC units included in the computation unit 340.

According to an embodiment, each of the plurality of types of MAC units included in the computation unit 340 may receive a weight value group and a feature value group as an input and output a result of performing a MAC operation thereon.

For example, an N-th type MAC unit 430, which is one of a plurality of MAC units, may receive, as an input, a weight value group 432 among the plurality of weight value groups and a feature value group 434 corresponding to the weight value group 432 and perform a MAC operation therebetween to output a partial sum 436.

According to an embodiment, the computation data processor 350 may collect partial sums output by performing MAC operations between weight value groups and corresponding feature value groups, and reorganize the collected partial sums to generate a transformed output feature map 440.

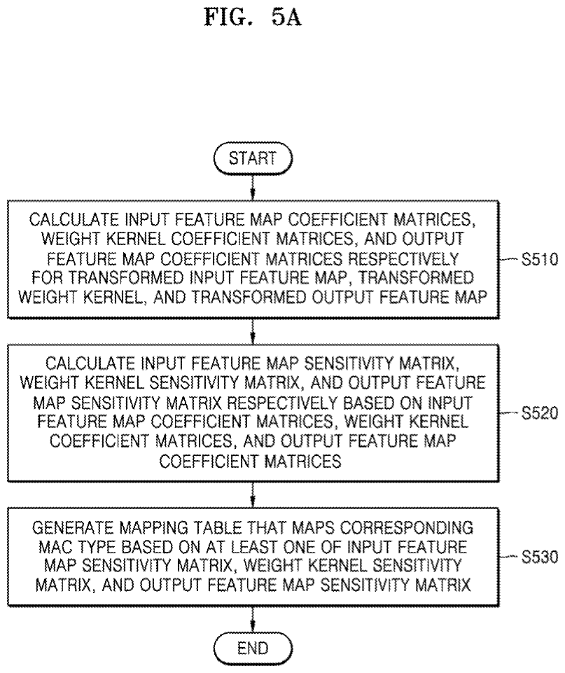

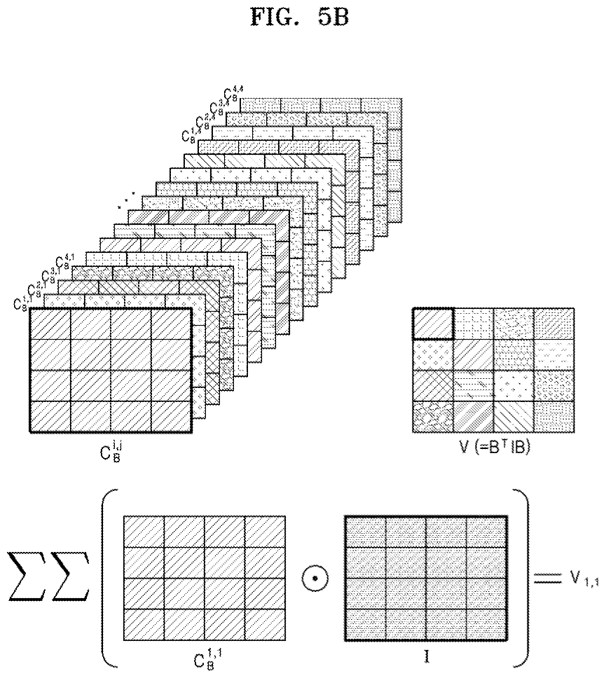

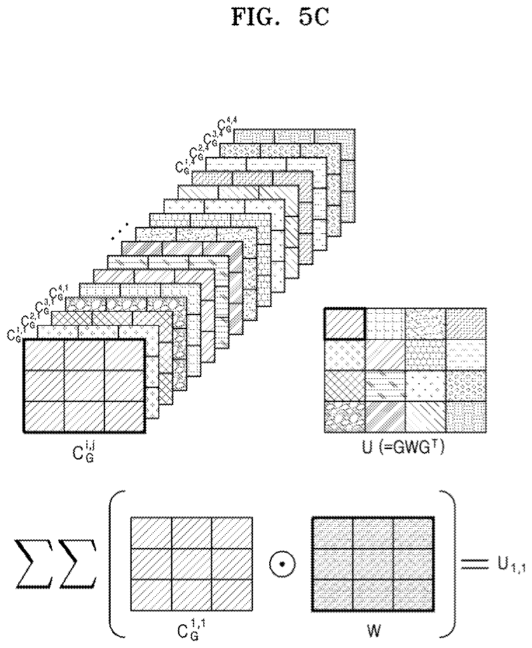

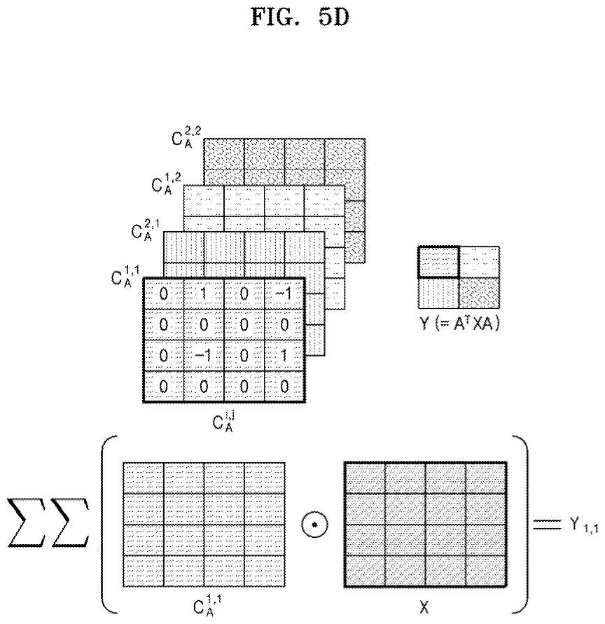

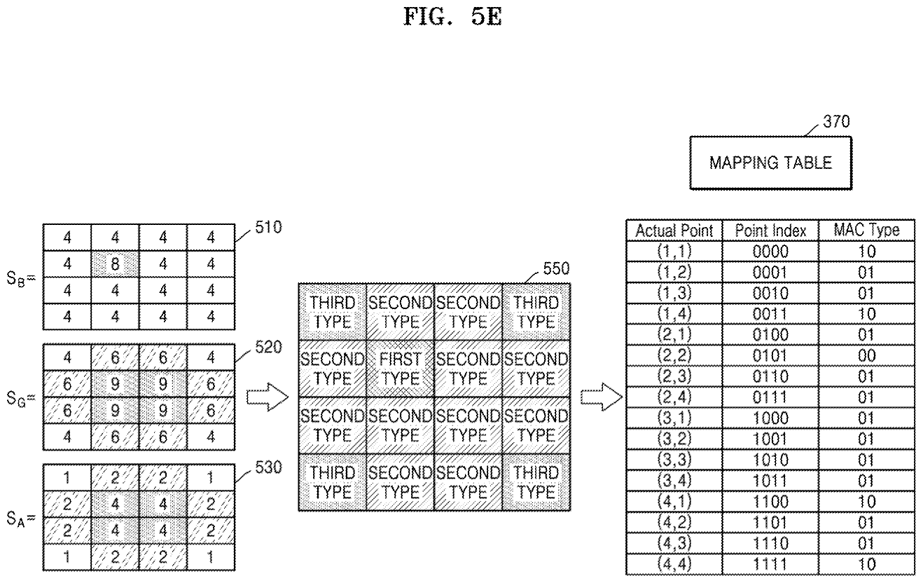

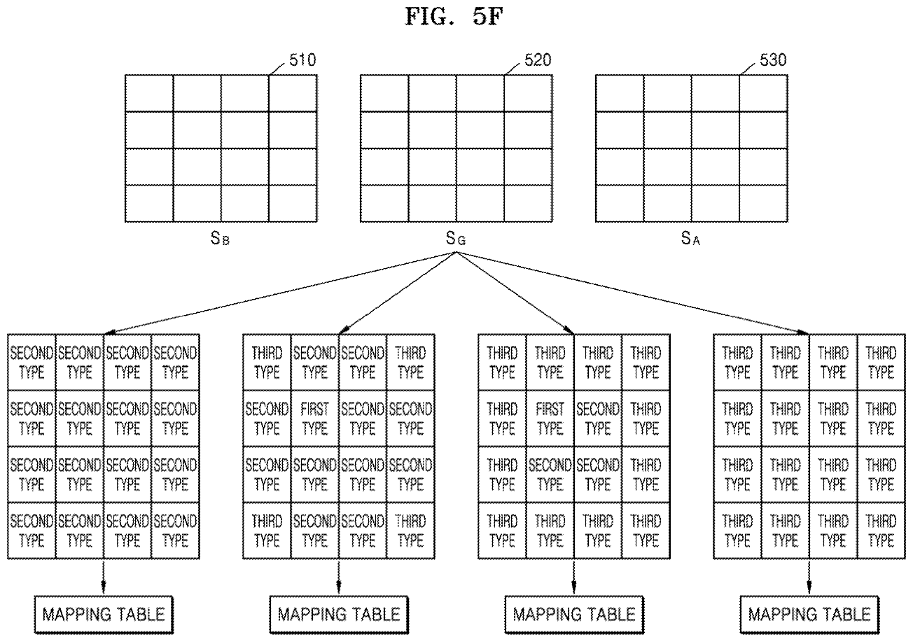

FIGS. 5A to 5F are diagrams referenced to describe an operation in which a transformation data processor included in the electronic device 300 performs mapping to a plurality of types of MAC units based on a mapping table, according to an embodiment.

In describing FIGS. 5A to 5F, the same components as those in FIGS. 3A to 3F are described using the same reference numerals. As described with reference to FIG. 3D, the transformation data processor 330 may map, based on the mapping table 370, a plurality of weight value groups and a plurality of feature value groups to a plurality of types of MAC units. In this case, the mapping table 370 may be pre-generated. For example, the mapping table 370 may be generated by a separate module (e.g., the statistical characteristics analyzer 380) outside of the electronic device 300. Hereinafter, for convenience of description, an embodiment in which a mapping table is generated by the statistical characteristics analyzer 380 is described.

FIG. 5A is a diagram referenced to describe a method of generating the pre-generated mapping table 370 provided by the statistical characteristics analyzer 380, according to an exemplary embodiment.

According to an embodiment, the pre-generated mapping table 370 may be obtained by the statistical characteristics analyzer 380 based on a transformed weight kernel, a transformed input feature map, and a transformed output feature map, which are obtained via transformation to the Winograd domain and have a matrix structure.

Referring to FIG. 5A, in operation S510, input feature map coefficient matrices C_{B}^{i,j}, weight kernel coefficient matrices C_{G}^{i,j}, and output feature map coefficients C_{A}^{i,j} may be respectively calculated for a transformed input feature map, a transformed weight kernel, and a transformed output feature map.

In detail, for a matrix B^{T}IB representing the transformed input feature map 240, a matrix (GWG^{T} representing the transformed weight kernel 230, and a matrix A^{T}XA representing the output feature map 270, a plurality of coefficient matrices C_{B}^{i,j}, C_{G}^{i,j}, and C_{A}^{i,j} may be respectively calculated using predefined computation processes. A detailed method of calculating the plurality of coefficient matrices C_{B}^{i,j}, C_{G}^{i,j}, and C_{A}^{i,j} is described in detail in the description with reference to FIGS. 5B to 5D.

In operation S520, an input feature map sensitivity matrix S_{B}, a weighted kernel sensitivity matrix S_{G}, and an output feature map sensitivity matrix S_{A} may be respectively calculated based on the input feature map coefficient matrices C_{B}^{i,j}, the weight kernel coefficient matrices C_{G}^{i,j}, and the output feature map coefficients C_{A}^{i,j}. A detailed method of calculating a plurality of sensitivity matrices S_{B}, S_{G}, and S_{A} based on a plurality of coefficient matrices C_{B}^{i,j}, C_{G}^{i,j}, and C_{A}^{i,j} is described in detail in the description with reference to FIGS. 5B to 5D. Also, in this case, as matrix elements in the sensitivity matrices S_{B}, S_{G}, and S_{A} have a higher value, it may mean that a higher precision is required when performing a MAC operation in the computation unit 340.

In operation S530, the statistical characteristics analyzer 380 according to an embodiment may generate, based on at least one of the input feature map sensitivity matrix, the weight kernel sensitivity matrix, and the output feature map sensitivity matrix, a mapping table that maps MAC unit types to correspond to sensitivity map elements, and provide the mapping table to the electronic device 300.

FIGS. 5B to 5D are diagrams for describing coefficient matrices and sensitivity matrices used to generate a mapping table.

Referring to FIG. 5B, input feature map coefficient matrices C_{B}^{i,j} may be defined based on a transformed input feature map V(=B^{T}IB) and an input feature map matrix I. The input feature map coefficient matrices C_{B}^{i,j} are matrices for obtaining a (i, j)th matrix element of the transformed input feature map matrix V(=B^{T}IB), and are defined as a matrix satisfying a relationship represented by Equation 1 below.

[B^{T}IB]_{i,j}=ΣΣ([C_{B}^{i,j}]⊙[I]) [Equation 1]

In Equation 1, B^{T}IB denotes a transformed input feature map matrix, C_{B}^{i,j} denotes an input feature map coefficient matrix, and I denotes an input feature map matrix.

A matrix element [B^{T}IB]_{i,j} at coordinates (i,j) in the transformed input feature map matrix B^{T}IB may be obtained based on the input feature map coefficient matrix C_{B}^{i,j} and the input feature map matrix I. Specifically, [B^{T}IB]_{i,j} may be obtained by performing an element-wise multiplication operation ⊙ between an input feature map coefficient matrix C_{B}^{i,j} corresponding to the coordinates (i, j) and the input feature map matrix I and then adding together all matrix elements of the resulting matrix. For example, in the transformed input feature map matrix V(=B^{T}IB), a matrix element V_{1,1} at coordinates (1,1) may be obtained by performing an element-wise multiplication ⊙ between an input feature map coefficient matrix C_{B}^{1,1} corresponding to the coordinates (1,1) and the input feature map matrix I and then adding all matrix elements of the resulting matrix.

In addition, because matrix elements in the input feature map coefficient matrix C_{B}^{i,j} that satisfies Equation 1 are elements that affect the matrix element [B^{T}IB]_{i,j} at coordinates (i, j) in the transformed input feature map matrix B^{T}IB, an input feature map sensitivity matrix S_{B} may be defined as in Equation 2 based on the input feature map coefficient matrix C_{B}^{i,j}.

[S_{B}]_{i,j}=ΣₘΣₙ|[C_{B}^{i,j}]_{m,n}| [Equation 2]

In Equation 2, S_{B} denotes an input feature map sensitivity matrix, and C_{B}^{i,j} denotes an input feature map coefficient matrix.

The matrix element [S_{B}]_{i,j} at coordinates (i, j) in the input feature map sensitivity matrix S_{B} may be obtained by adding together absolute values of all matrix elements of the input feature map coefficient matrix C_{B}^{i,j} corresponding to coordinates (i, j).

Referring to FIG. 5C, weight kernel coefficient matrices C_{G}^{i,j} may be defined based on a transformed weight kernel matrix U(=GWG^{T}) and a weight kernel matrix W. The weight kernel coefficient matrices C_{G}^{i,j} are matrices for obtaining a (i, j)th matrix element of the transformed weight kernel matrix U(=GWG^{T}), and are defined as a matrix satisfying a relationship represented by Equation 3 below.

[GWG^{T}]_{i,j}=ΣΣ([C_{G}^{i,j}]⊙[W]) [Equation 3]

In Equation 3, GWG^{T} denotes a transformed weight kernel matrix, C_{G}^{i,j} denotes a weight kernel coefficient matrix, and W denotes a weight kernel matrix.

A matrix element [GWG^{T}]_{i,j} at coordinates (i,j) in the transformed weight kernel matrix GWG^{T} may be obtained based on the weight kernel coefficient matrix C_{G}^{i,j} and the weight kernel matrix W. Specifically, [GWG^{T}]_{i,j} may be obtained by performing an element-wise multiplication operation ⊙ between an weight kernel coefficient matrix C_{G}^{i,j} corresponding to the coordinates (i, j) and the weight kernel matrix W and then adding together all matrix elements of the resulting matrix. For example, in the transformed weight kernel matrix U(=GWG^{T}), a matrix element U_{1,1} at coordinates (1,1) may be obtained by performing an element-wise multiplication ⊙ between a weight kernel coefficient matrix C_{G}^{1,1} corresponding to the coordinates (1,1) and the weight kernel matrix W and then adding all matrix elements of the resulting matrix.

In addition, because matrix elements in the weight kernel coefficient matrix C_{G}^{i,j} that satisfies Equation 3 are elements that affect the matrix element [GWG^{T}]_{i,j} at coordinates (i, j) in the transformed weight kernel matrix GWG^{T}, a weight kernel sensitivity matrix S_{G} may be defined as in Equation 4 based on the weight kernel coefficient matrix C_{G}^{i,j}.

[S_{G}]_{i,j}=ΣₘΣₙ|[C_{G}^{i,j}]_{m,n}| [Equation 4]

In Equation 4, S_{G} denotes a weight kernel sensitivity matrix, and C_{G}^{i,j} denotes a weight kernel coefficient matrix.

The matrix element [S_{G}]_{i,j} at coordinates (i, j) in the weight kernel sensitivity matrix S_{G} may be obtained by adding together absolute values of all matrix elements of the weight kernel coefficient matrix C_{G}^{i,j} corresponding to coordinates (i, j).

Referring to FIG. 5D, output feature matrix coefficient matrices C_{A}^{i,j} may be defined based on an output feature map matrix Y(=A^{T}XA) and a transformed output feature map matrix X. The output feature map matrix Y(=A^{T}XA) may be obtained by performing an inverse Winograd transform on the transformed output feature map X. Furthermore, the output feature map coefficient matrices C_{A}^{i,j} are matrices for obtaining a (i, j)th matrix element of the output feature map matrix Y(=A^{T}XA), and are defined as a matrix satisfying a relationship represented by Equation 5 below.

[A^{T}XA]_{i,j}=ΣΣ([C_{A}^{i,j}]⊙[X]) [Equation 5]

In Equation 5, A^{T}XA denotes an output feature map matrix, C_{A}^{i,j} denotes an output feature map coefficient matrix, and X denotes a transformed output feature map matrix.

A matrix element [A^{T}XA]_{i,j} at coordinates (i, j) in the output feature map matrix A^{T}XA may be obtained based on the output feature map coefficient matrix C_{A}^{i,j} and the transformed output feature map matrix X. Specifically, [A^{T}XA]_{i,j} may be obtained by performing an element-wise multiplication operation ⊙ between an output feature map coefficient matrix C_{A}^{i,j} corresponding to the coordinates (i, j) and the transformed output feature map matrix X and then adding together all matrix elements of the resulting matrix. For example, in the output feature map matrix Y(=A^{T}XA), a matrix element Y_{1,1} at coordinates (1,1) may be obtained by performing an element-wise multiplication ⊙ between an output feature map coefficient matrix C_{A}^{1,1} corresponding to the coordinates (1,1) and the transformed output feature map matrix X and then adding all matrix elements of the resulting matrix.

In addition, because matrix elements in the output feature map coefficient matrix C_{A}^{i,j} that satisfies Equation 5 are elements that affect the matrix element [A^{T}XA]_{i,j} at coordinates (i, j) in the output feature map matrix A^{T}XA, an output feature map sensitivity matrix may be defined as in Equation 6 based on the output feature map coefficient matrix C_{A}^{i,j}.

[S_{A}]_{i,j}=(ΣₘΣₙ|[C_{A}^{m,n}]|)_{i,j} [Equation 6]

In Equation 6, S_{A} denotes an output feature map sensitivity matrix, and C_{A}^{m,n} denotes an output feature map coefficient matrix.

The matrix element [S_{A}]_{i,j} at coordinates (i, j) in the output feature map sensitivity matrix S_{A} may be a matrix element at coordinates (i, j) in a matrix obtained by adding together absolute values of all output feature map coefficient matrices.

FIG. 5E is a diagram for describing a pre-generated mapping table referred to when the electronic device 300 maps a plurality of types of MAC units, according to an embodiment.

A plurality of types of MAC units mapped based on the mapping table 370 may perform MAC operations in different modes for each MAC unit type. In this case, because the plurality of types of MAC units each receive an input with reduced precision by reducing a bit length of an input value in different ways and restore the precision of the input to output a MAC result, the degree to which an output value is reconstructed is different for each MAC unit type.

Therefore, the statistical characteristics analyzer 380 may generate, based on at least one of the weighted kernel sensitivity matrix, the input feature map sensitivity matrix, and the output feature map sensitivity matrix, a mapping table so that a MAC unit type with lower precision loss is mapped to correspond to a sensitivity matrix element requiring higher precision.

In detail, referring to an input feature map sensitivity matrix 510, a matrix element at coordinates (2, 2) in the input feature map sensitivity matrix 510 may have a highest value. In this case, the statistical characteristics analyzer 380 may map, as a MAC unit type corresponding to the matrix element at coordinates (2,2), a MAC unit type with lower precision loss than MAC unit types corresponding to the remaining matrix elements at the other coordinates.

Also, referring to a weighted kernel sensitivity matrix 520, matrix elements at coordinates (1,1), (1,4), (4,1), and (4,4) in the weighted kernel sensitivity matrix 520 may have a lowest value, matrix elements at coordinates (1,2), (1,3), (2,1), (2,4), (3,1), (3,4), (4,2), and (4,3) may have an intermediate value, and matrix elements at coordinates (2,2), (2,3), (3,2), and (3,3) may have a highest value. In this case, the statistical characteristics analyzer 380 may map a MAC unit type with lower precision loss to correspond to a matrix element having a higher value.

In addition, because the same description as for the weight kernel sensitivity matrix 520 is applied to an output feature map sensitivity matrix 530, a description thereof will be omitted herein.

According to an embodiment, the statistical characteristics analyzer 380 may generate a mapping matrix 550 that maps a MAC unit type for performing a MAC operation to a weight value group and a feature value group, and create the mapping table 370 based on the mapping matrix 550.

Referring to FIG. 5F, as described in FIG. 5E, the statistical characteristics analyzer 380 may generate the mapping table 370 by mapping MAC unit types in different ways based on at least one of the input feature map sensitivity matrix 510, the weighted kernel sensitivity matrix 520, and the output feature map sensitivity matrix 530.

According to an embodiment, the transformation data processor 330 may output, based on the mapping table 370 generated through the above-described processes, a plurality of weight value groups and a plurality of feature value groups to a plurality of types of MAC units mapped thereto.

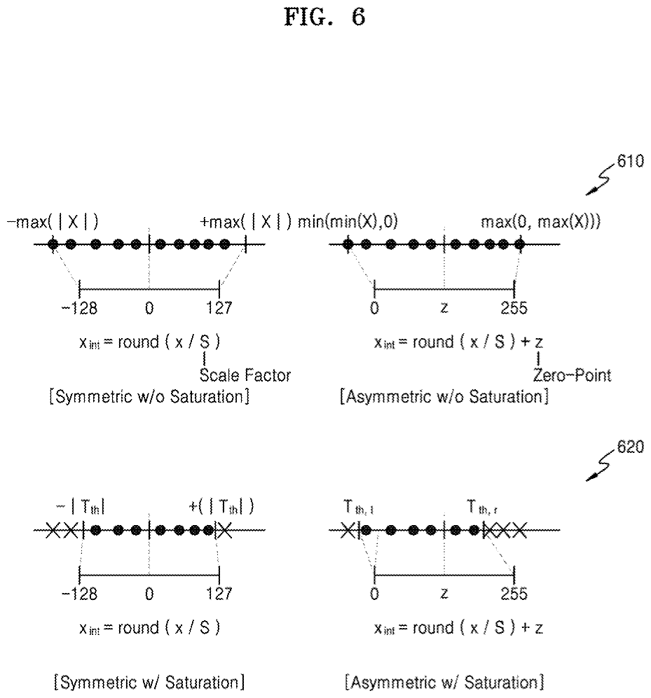

FIG. 6 is a diagram referenced to describe a method of quantizing values input to an electronic device, according to an embodiment.

In order for the electronic device 300 according to an embodiment to perform computation using a trained neural network model, an input value may need to be converted from floating-point precision to fixed-point precision via quantization. The electronic device 300 may receive an input value having a bit length reduced via quantization to perform computation thereon.

A method of quantizing input values for the electronic device 300 may be a quantization method 610 based on maximum-minimum values. For example, a maximum-minimum based quantization method may be used to convert input values to values having a smaller bit length (e.g., 8 bits) based on maximum and minimum values of values included in a weight kernel and values included in an input feature map. In this case, the input values may be quantized to values between −128 and 127 centered on a zero point, or quantized to values between 0 and 255 with respect to the zero point.

Also, a method of quantizing input values for the electronic device 300 may be a quantization method 620 based on threshold values. For example, a threshold-based quantization method may involve determining a maximum threshold value and a minimum threshold value among values included in a weight kernel and values included in an input feature map, and converting input values to values having a smaller bit length (e.g., 8 bits) based on the maximum threshold value and the minimum threshold value. In this case, the input values may be quantized to values between −128 and 127 centered on the zero point, or quantized to values between 0 and 255 with respect to the zero point.

Furthermore, a method of quantizing input values for the electronic device 300 may be determined based on characteristics of the input values. For example, when an input value is a value representing a weight kernel, weight values are fixed as the neural network model is defined, and thus, maximum and minimum values of the weight values may be already clear. In this case, the quantization method may be the quantization method 610 based on maximum-minimum values. In another example, when an input value is a value representing an input feature map, maximum and minimum values of feature values may not be clearly fixed because arbitrary data may be input. In this case, the quantization method may be the quantization method 620 based on threshold values. Although the method of quantizing an input value and converting it to fixed-point precision has been described through the above-described embodiments, the quantization method is not limited thereto, and an input value input to the electronic device 300 may be quantized using various quantization schemes.

According to an embodiment, the computation unit 340 may receive a fixed-point number via conversion using quantization and perform a shift operation and a MAC operation thereon.

FIGS. 7A to 7C are diagrams referenced to describe a first type MAC unit among a plurality of types of MAC units for performing MAC operations between a weight value group and a feature value group.

In the description with respect to FIGS. 7A to 7C, a first type MAC unit, which is one of a plurality of types of MAC units that may be included in a computation unit, is described as a reference. One first type MAC unit may output a partial sum by performing a MAC operation between a weight value group and a feature value group.

FIG. 7A is a diagram for describing a structure of a multiplier unit included in a first type MAC unit, according to an embodiment.

Referring to FIG. 7A, the first type MAC unit may include a plurality of multiplier units 710 and an accumulator 750 that accumulates and adds outputs respectively from the plurality of multiplier units. Hereinafter, for convenience of description, the multiplier unit 710 that is one of the plurality of multiplier units is described as a reference.

According to an embodiment, the multiplier unit 710 may include a cross shift unit 720, a multiplier 730, and a restoration shifter 740, and the cross shift unit 720 may include a first shifter 722 and a second shifter 724.

According to an embodiment, the first shifter 722 included in the cross shift unit 720 may receive a first fixed-point number representing a weight value to perform a right shift operation by using the first shifting method.

In detail, when a bit length of the input first fixed-point number does not exceed a preset first bit length, the first shifter 722 may bypass the first fixed-point number. Also, when the bit length of the input first fixed-point number exceeds the preset first bit length, the first shifter 722 may reduce the bit length by shifting the first fixed-point number to the right by a bit length N_{W} in excess of the first bit length. In this case, the first bit length may correspond to an input bit length of a first input fed to the multiplier.

According to an embodiment, the second shifter 724 included in the cross shift unit 720 may receive a second fixed-point number representing a feature value to perform a right shift operation by using the first shifting method.

In detail, when a bit length of the input second fixed-point number does not exceed a preset second bit length, the second shifter 724 may bypass the second fixed-point number. Also, when the bit length of the input second fixed-point number exceeds the preset second bit length, the second shifter 724 may reduce the bit length by shifting the second fixed-point number to the right by a bit length N_{D} in excess of the second bit length. In this case, the second bit length may correspond to an input bit length of a second input fed to the multiplier.

According to an embodiment, the cross shift unit 720 may exchange the value of the first fixed-point number and the value of the second fixed-point number, based on at least one of a value of the first fixed-point number, the first bit length, a value of the second fixed-point number, and the second bit length, so that the value of the first fixed-point number and the value of the second fixed-point number are input in a crossed manner. In this case, the first fixed-point number may be input to the second shifter 724 to perform a right shift operation, and the second fixed-point number may be input to the first shifter 722 to perform a right shift operation. A method, performed by the cross shift unit 720 of exchanging the value of the first fixed-point number and the value of the second fixed-point number is described in more detail with reference to FIG. 7B.

According to an embodiment, the multiplier 730 may receive a value of the first bit length output from the first shifter 722 and a value of the second bit length output from the second shifter 724 to perform a multiplication operation between the values.

According to an embodiment, the restoration shifter 740 may receive a multiplication operation result output from the multiplier 730 to perform a left shift operation for restoring a bit length. In detail, the restoration shifter 740 may restore a bit length by shifting the multiplication operation result output from the multiplier 730 to the left by a sum of the bit length N_{W} by which the first shifter 722 shifts right and the bit length N_{D} by which the second shifter 724 shifts right. Also, N_{W}+N_{D}, which is a bit length by which the restoration shifter 740 shifts the multiplication operation result to the left, may be received from the cross shift unit 720.

According to an embodiment, the accumulator 750 may accumulate and add values output from the plurality of multiplier units included in the first type MAC unit. The accumulator 750 may include an adder and a register.

FIG. 7B is a diagram referenced to describe operations of the multiplier unit 710, according to an embodiment.

According to an embodiment, the cross shift unit 720 may allow a value of a first fixed-point number and a value of a second fixed-point number to be exchanged and input, based on the value of the first fixed-point number, a first bit length, the value of the second fixed-point number, and a second bit length.

Hereinafter, referring to an example table 705 for convenience of description, operations of the multiplier unit 710 are described by considering an example in which a bit length of a weight value (the first fixed-point number) is 20 bits, a bit length of a feature value (the second fixed-point number) is 12 bits, the first bit length that is a bit length of a first input value fed to the multiplier 730 is 16 bits, and the second bit length that is a bit length of a second input value fed to the multiplier 730 is 10 bits.

In operation S710, according to an embodiment, the multiplier unit 710 may receive the first fixed-point number representing the weight value and the second fixed-point number representing the feature value. For example, the multiplier unit 710 may receive the 20-bit first fixed-point number representing the weight value and the 12-bit second fixed-point number representing the feature value.

In operation S720, according to an embodiment, the cross shift unit 720 may exchange the value of the first fixed-point number and the value of the second fixed-point number, so that the first fixed-point number and the second fixed-point number are respectively input in a crossed manner to the second shifter 724 and the first shifter 722.

For example, when they are not input in a crossed manner, the 20-bit first fixed-point number may be input to the first shifter 722 and shifted to the right by 4 bits, and the 12-bit second fixed-point number may be input to the second shifter 724 and shifted to the right by 2 bits. However, if the value of the 12-bit second fixed-point number is greater than 2\hat{ }10, precision loss may occur when the second fixed-point number is input to the second shifter 724 and shifted to the right by 2 bits. In this case, if the value of the 20-bit first fixed-point number is less than 2\hat{ }12 and the value of the 12-bit second fixed-point number is greater than 2\hat{ }10, the cross shift unit 720 may allow the first fixed-point number to be input to the second shifter 724 and shifted to the right by 4 bits and the second fixed-point number to be input to the first shifter 722 and shifted to the right by 2 bits, thereby preventing precision loss with respect to the second fixed-point number. However, the present disclosure is not limited thereto, and instead of exchanging the values of the first fixed-point number and the second fixed-point number, the cross shift unit 720 may allow the value of the first fixed-point number and the value of the second fixed-point number to be respectively input to the first shifter 722 and the second shifter 724.

In operation S730, according to an embodiment, the first shifter 722 may shift the first fixed-point number to the right based on the first bit length.

For example, when the first fixed-point number has a bit length of 20 bits and the first bit length indicating a bit length input to the multiplier is 16 bits, the first shifter 722 may shift the first fixed-point number right by 4 bits.

In operation S740, according to an embodiment, the second shifter 724 may shift the second fixed-point number to the right based on the second bit length.

For example, when the second fixed-point number has a bit length of 12 bits and the second bit length indicating another bit length input to the multiplier is 10 bits, the second shifter 724 may shift the second fixed-point number right by 2 bits. Although operations S730 and S740 are shown sequentially in FIG. 7B, this is merely an example for convenience of description, and operations S730 and S740 may be performed in parallel.

In operation S750, according to an embodiment, the multiplier 730 may receive an output value obtained via shifting by the first shifter 722 and an output value obtained via shifting by the second shifter 724 and perform a multiplication operation between the output values.

For example, the multiplier 730 may receive a value obtained by the first shifter 722 shifting the first fixed-point number by 4 bits and a value obtained by the second shifter 724 shifting the second fixed-point number by 2 bits and perform a multiplication operation between the values.

In operation S760, according to an embodiment, the restoration shifter 740 may receive a multiplication operation result from the multiplier 730 and perform a left shift operation thereon to restore the bit length. Specifically, the restoration shifter 740 may shift the multiplication operation result from the multiplier 730 to the left by a sum of the bit length by which the first shifter 722 shifts the first fixed-point number to the right and the bit length by which the second shifter 724 shifts the second fixed-point number to the right.

For example, when the first shifter 722 shifts the first fixed-point number to the right by 4 bits and the second shifter 724 shifts the second fixed-point number to the right by 2 bits, the restoration shifter 740 may shift the multiplication operation result output from the multiplier 730 to the left by 6 bits.

According to an embodiment, the multiplier unit 710 may generate lower bit-width values by shifting input values to the right, perform a multiplication operation on the lower bit-width values, and restore a bit length by shifting a multiplication operation result back to the left. Accordingly, the hardware area of the multiplier unit may be reduced by performing computation on lower bit-widths, while minimizing precision loss that occurs during the computation.

FIG. 7C is a diagram referenced to describe the overall structure of a first type MAC unit according to an embodiment.

Referring to FIG. 7C, a first type MAC unit 700 may include a plurality of multiplier units and an accumulator 750. As described above with reference to FIG. 3D, a weight value group may include a plurality of weight values located at the same matrix coordinates. Also, a feature value group may include a plurality of feature values located at the same matrix coordinates.

For example, when the transformed feature map and the transformed weight kernel each consist of N channels, one weight value group may include N weight values, and one feature value group may include N feature values. In this case, the first type MAC unit may perform a MAC operation by respectively multiplying weight values (weight value A to weight value N) by feature values (feature value A to feature value N) and adding together their multiplication results.

The first type MAC unit may output a partial sum by performing a MAC operation between the weight value group and the feature value group, i.e., by respectively obtaining multiplication operation results (multiplication operation result A to multiplication operation result N) from the plurality of multiplier units and accumulating and adding the plurality of multiplication operation results using the accumulator 750.

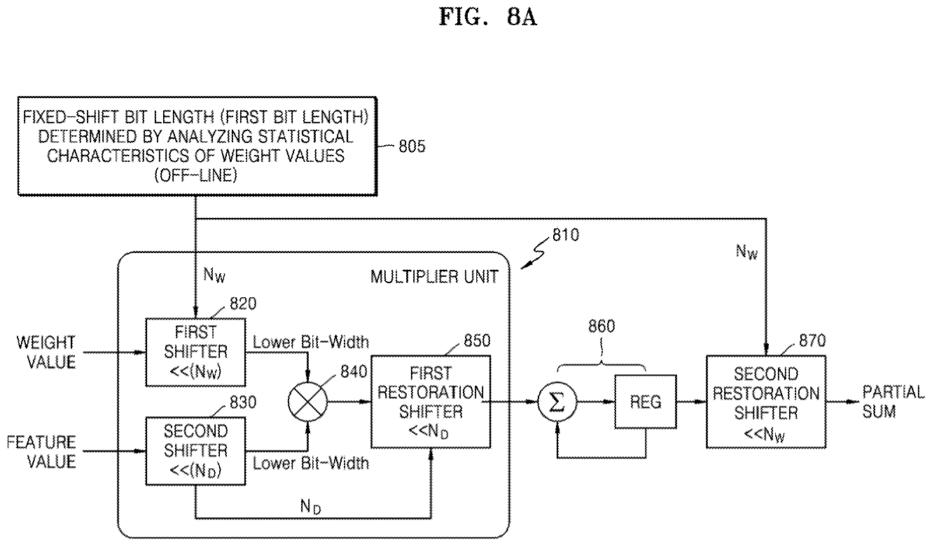

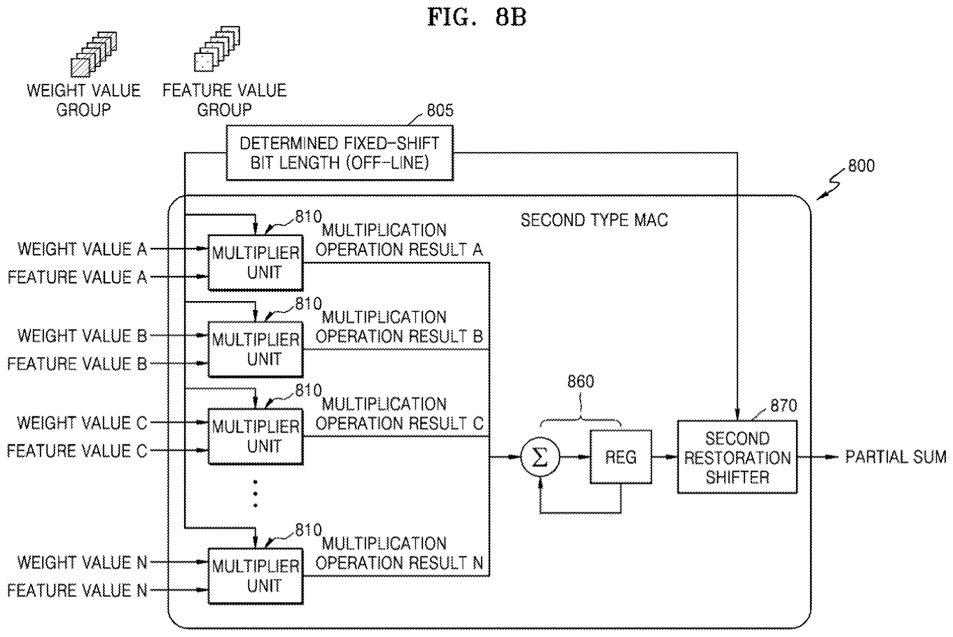

FIGS. 8A and 8B are diagrams referenced to describe a second type MAC unit among a plurality of types of MAC units for performing MAC operations between weight value groups and corresponding feature value groups.

In the description with respect to FIGS. 8A and 8B, a second type MAC unit, which is one of a plurality of types of MAC units that may be included in a computation unit, is described as a reference. One second type MAC unit may output a partial sum by performing a MAC operation between a weight value group and a feature value group.

FIG. 8A is a diagram for describing a structure of a multiplier unit included in a second type MAC unit, according to an embodiment.

Referring to FIG. 8A, the second type MAC unit may include a plurality of multiplier units 810, an accumulator 860 that accumulates and adds outputs respectively from the plurality of multiplier units, and a second restoration shifter 870 that restores a bit length by shifting an output value of the accumulator 860 to the left. Hereinafter, for convenience of description, the multiplier unit 810 that is one of the plurality of multiplier units is described as a reference.

According to an embodiment, the multiplier unit 810 may include a first shifter 820, a second shifter 830, a multiplier 840, and a first restoration shifter 850.

According to an embodiment, the first shifter 820 may receive a first fixed-point number representing a weight value to perform a right shift operation by using the second shifting method.

In detail, the first shifter 820 may reduce a bit length of the received first fixed-point number by shifting the first fixed-point number to the right by a first bit length N_{W}, which is a fixed-shift bit length, regardless of the bit length of the first fixed-point number. In this case, the first bit length may be a value determined by a statistical characteristics analyzer 805 based on a result of analyzing statistical characteristics of weight values off-line. A method, performed by the statistical characteristics analyzer 805, of determining the first bit length that is the fixed-shift bit length is described in detail below with reference to FIG. 11.

According to an embodiment, the second shifter 830 may receive a second fixed-point number representing a feature value to perform a right shift operation by using the first shifting method.

When a bit length of the received second fixed-point number does not exceed a preset second bit length, the second shifter 830 may bypass the second fixed-point number. Also, when the bit length of the received second fixed-point number exceeds the preset second bit length, the second shifter 830 may reduce the bit length by shifting the second fixed-point number to the right by a bit length N_{D} in excess of the second bit length.

According to an embodiment, the multiplier 840 may receive a value output from the first shifter 820 (a value obtained by shifting the first fixed-point number to the right by the first bit length) and a value of the second bit length output from the second shifter 830 to perform a multiplication operation between the values.

According to an embodiment, the first restoration shifter 850 may receive a multiplication operation result output from the multiplier 840 to perform a left shift operation for restoring a bit length.

In detail, the first restoration shifter 850 may restore a bit length by shifting the multiplication operation result output from the multiplier 840 to the left by the bit length N_{D} by which the second shifter 830 performs the right shift. Also, the bit length N_{D} by which the first restoration shifter 850 shifts the multiplication operation result to the left may be received from the second shifter 830.

According to an embodiment, the accumulator 860 may accumulate and add values output from the plurality of multiplier units included in the second type MAC unit. The accumulator 860 may include an adder and a register.

According to an embodiment, the second restoration shifter 870 may receive an operation result output from the accumulator 860 and perform a left shift operation for restoring a bit length.

Specifically, the second restoration shifter 870 may restore the bit length by shifting a multiplication operation result output from the accumulator 860 to the left by the bit length N_{W} by which the first shifter 820 shifts right. Also, the bit length N_{W} by which the second restoration shifter 870 shifts the multiplication operation result to the left may be received from the statistical characteristics analyzer 805.

In another embodiment, when a neural network model is defined, weight values may be fixed so that maximum and minimum values thereof may be clear, and accordingly, an operation of shifting right by the first bit length may be processed in advance. In this case, the multiplier unit 810 may not include the first shifter. That is, a value having a bit length reduced by shifting a weight value right by the first bit length via offline processing may be input to the multiplier 840.

FIG. 8B is a diagram referenced to describe the overall structure of a second type MAC unit according to an embodiment.

Referring to FIG. 8B, a second type MAC unit 800 may include a plurality of multiplier units, an accumulator 860, and a second restoration shifter 870. As described above with reference to FIG. 3D, a weight value group may include a plurality of weight values located at the same matrix coordinates. Also, a feature value group may include a plurality of feature values located at the same matrix coordinates.

For example, when the transformed feature map and the transformed weight kernel each consist of N channels, one weight value group may include N weight values, and one feature value group may include N feature values. In this case, the second type MAC unit 800 may perform a MAC operation by respectively multiplying weight values (weight value A to weight value N) by feature values (feature value A to feature value N) and adding together their multiplication results.

The second type MAC unit 800 may output a partial sum by performing a MAC operation between the weight value group and the feature value group, i.e., by respectively obtaining multiplication operation results (multiplication operation result A to multiplication operation result N) from the plurality of multiplier units, accumulating and adding the plurality of multiplication operation results using the accumulator 860, and restoring, by using the second restoration shifter 870, bit lengths respectively reduced by the plurality of multiplier units shifting right by the fixed-shift bit length (the first bit length).

The plurality of multiplier units 810 may reduce bit lengths by shifting weight values respectively input thereto by using the second shifting method, and the second restoration shifter 870 may be used to restore the reduced bit lengths to the original ones. In other words, the plurality of multiplier units 810 may collectively shift the weight values to the right by the first bit length that is a bit length determined by the statistical characteristics analyzer 805. Therefore, the plurality of multiplier units 810 may share a value of the first bit length to allow the second restoration shifter 870 to collectively restore reduced bit lengths during restoration.

In addition, the plurality of multiplier units 810 may reduce bit lengths by shifting feature values respectively input thereto by using the first shifting method, and use the second restoration shifter 870 to restore the reduced bit lengths to the original ones. However, the present disclosure is not limited thereto, and the plurality of multiplier units 810 may perform a MAC operation by shifting weight values using the first shifting method while shifting feature values using the second shifting method.

According to an embodiment, the plurality of multiplier units 810 may share a single second restoration shifter 870 to restore bit lengths of pieces of data reduced by the plurality of multiplier units shifting the pieces of data by using the second shifting method, thereby reducing the number of shifters used in the MAC unit and thus reducing the hardware area covered by the multiplier units 810 and the second type MAC unit 800 including the multiplier units 810.

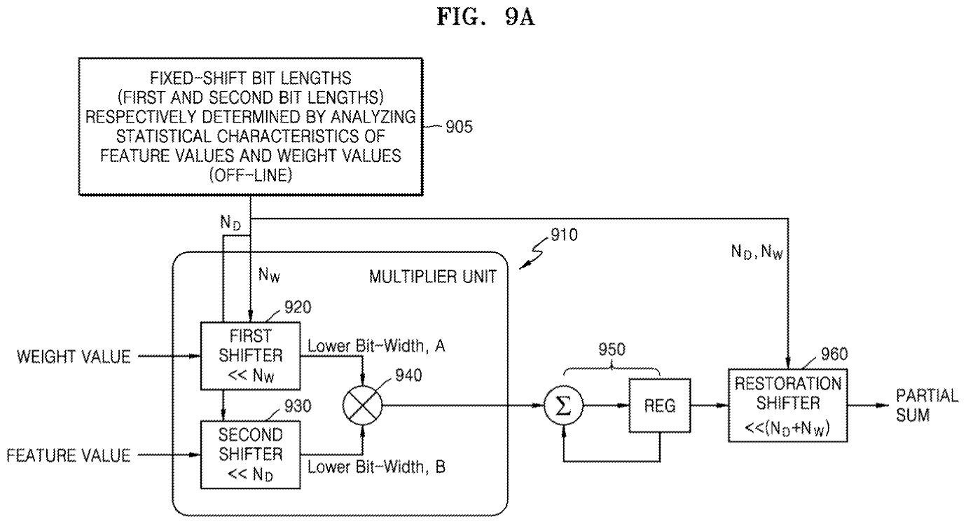

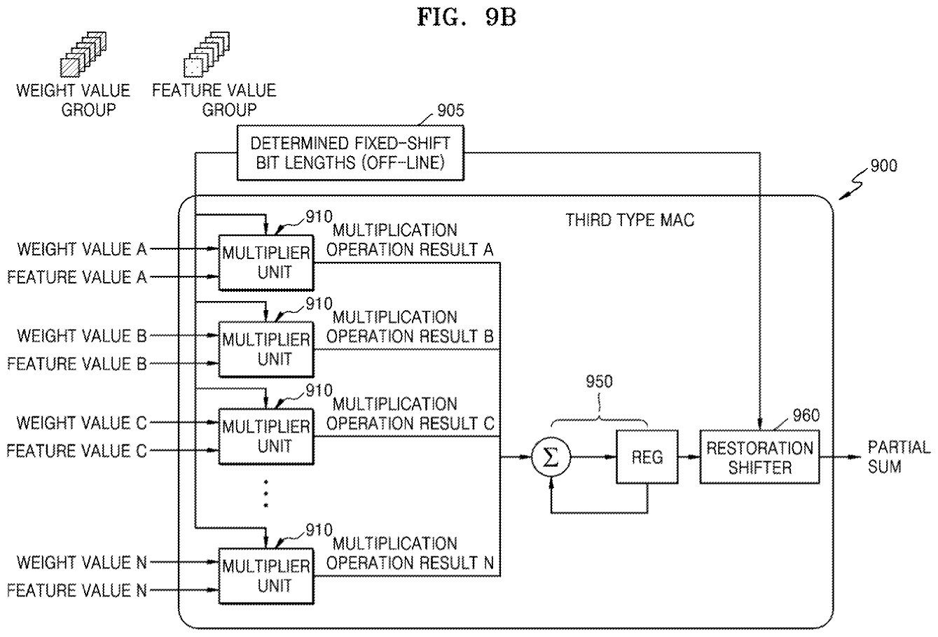

FIGS. 9A and 9B are diagrams referenced to describe a third type MAC unit among a plurality of types of MAC units for performing MAC operations between a weight value group and a feature value group.

In the description with respect to FIGS. 9A and 9B, a third type MAC unit, which is one of a plurality of types of MAC units that may be included in a computation unit, is described as a reference. One third type MAC unit may output a partial sum by performing a MAC operation between a weight value group and a feature value group.

FIG. 9A is a diagram for describing a structure of a multiplier unit included in a third type MAC unit, according to an embodiment.

Referring to FIG. 9A, the third type MAC unit may include a plurality of multiplier units 910, an accumulator 950 that accumulates and adds outputs respectively from the plurality of multiplier units, and a restoration shifter 960 that restores a bit length by shifting an output value of the accumulator 950 to the left. Hereinafter, for convenience of description, the multiplier unit 910 that is one of the plurality of multiplier units is described as a reference.

According to an embodiment, the multiplier unit 810 may include a first shifter 920, a second shifter 930, and a multiplier 940.

According to an embodiment, the first shifter 920 may receive a first fixed-point number representing a weight value to perform a right shift operation by using the second shifting method.

In detail, the first shifter 920 may reduce a bit length of the received first fixed-point number by shifting the first fixed-point number to the right by a first bit length N_{W}, which is a fixed-shift bit length, regardless of the bit length of the first fixed-point number.

In this case, the first bit length may be a value determined by a statistical characteristics analyzer 905 based on a result of analyzing statistical characteristics of weight values off-line. A method, performed by the statistical characteristics analyzer 905, of determining the first bit length that is the fixed-shift bit length is described in detail below with reference to FIG. 11.

According to an embodiment, the second shifter 930 may receive a second fixed-point number representing a feature value to perform a right shift operation by using the second shifting method.

In detail, the second shifter 930 may reduce a bit length of the received second fixed-point number by shifting the second fixed-point number to the right by a second bit length N_{D}, which is a fixed-shift bit length, regardless of the bit length of the second fixed-point number. In this case, the second bit length may be a value determined by the statistical characteristics analyzer 905 based on a result of analyzing statistical characteristics of feature values off-line. A method, performed by the statistical characteristics analyzer 905, of determining the second bit length that is the fixed-shift bit length is described in detail below with reference to FIG. 11.

According to an embodiment, the multiplier 940 may receive a value output from the first shifter 920 (a value obtained by shifting the first fixed-point number to the right by the first bit length) and a value output from the second shifter 930 (a value obtained by shifting the second fixed-point number to the right by the second bit length) to perform a multiplication operation between the values.

According to an embodiment, the accumulator 950 may accumulate and add values output from the plurality of multiplier units included in the third type MAC unit. The accumulator 950 may include an adder and a register.

According to an embodiment, the restoration shifter 960 may receive an operation result output from the accumulator 950 and perform a left shift operation for restoring a bit length.

In detail, the restoration shifter 960 may restore a bit length by shifting the multiplication operation result output from the accumulator 950 to the left by a sum (N_{W}+N_{D}) of the bit length N_{W} by which the first shifter 920 shifts right and the bit length N_{W} by which the second shifter 930 shifts right. Also, N_{W}+N_{D}, which is a bit length by which the restoration shifter 960 shifts the multiplication operation result to the left, may be received from the statistical characteristics analyzer 905.

In another embodiment, when a neural network model is defined, weight values may be fixed so that maximum and minimum values thereof may be clearly designated, and accordingly, an operation of shifting right by the first bit length may be processed in advance. In this case, the multiplier unit 910 may not include the first shifter. That is, a value having a bit length reduced by shifting a weight value right by the first bit length via off-line processing may be input to the multiplier 940.

FIG. 9B is a diagram referenced to describe the overall structure of a third type MAC unit according to an embodiment.

Referring to FIG. 9B, a third type MAC unit 900 may include a plurality of multiplier units, an accumulator 950, and a restoration shifter 960. As described above with reference to FIG. 3D, a weight value group may include a plurality of weight values located at the same matrix coordinates. Also, a feature value group may include a plurality of feature values located at the same matrix coordinates.

For example, when the transformed feature map and the transformed weight kernel each consist of N channels, one weight value group may include N weight values and one feature value group may include N feature values. In this case, the third type MAC unit 900 may perform a MAC operation by respectively multiplying weight values (weight value A to weight value N) by feature values (feature value A to feature value N) and adding together their multiplication results.

The third type MAC unit 900 may output a partial sum by performing a MAC operation between the weight value group and the feature value group, i.e., by respectively obtaining multiplication operation results (multiplication operation result A to multiplication operation result N) from the plurality of multiplier units, accumulating and adding the plurality of multiplication operation results using the accumulator 950, and restoring, by using the restoration shifter 960, bit lengths respectively reduced by the plurality of multiplier units shifting right by the fixed-shift bit lengths (the first and second bit lengths).

According to an embodiment, the plurality of multiplier units 910 may reduce bit lengths by shifting transformed weight values and feature values respectively input thereto by using the second shifting method, and use the restoration shifter 960 to restore the reduced bit lengths to the original ones. In other words, the plurality of multiplier units 910 may collectively shift the weight values to the right by the first bit length that is a bit length determined by the statistical characteristics analyzer 905 off-line. In addition, the plurality of multiplier units 910 may collectively shift the feature values to the right by the second bit length that is a bit length determined by the statistical characteristics analyzer 905 off-line. Thus, the plurality of multiplier units 910 may share a value of the first bit length and a value of the second bit length to allow the restoration shifter 960 to collectively restore reduced bit lengths during restoration.

According to an embodiment, the plurality of multiplier units 910 may share a single restoration shifter 960 to restore bit lengths of pieces of data reduced by the plurality of multiplier units shifting the pieces of data using the second shifting method, thereby reducing the number of shifters used in the MAC unit and thus reducing the hardware area covered by the multiplier units 910 and the third type MAC unit 900 including the multiplier units 910.

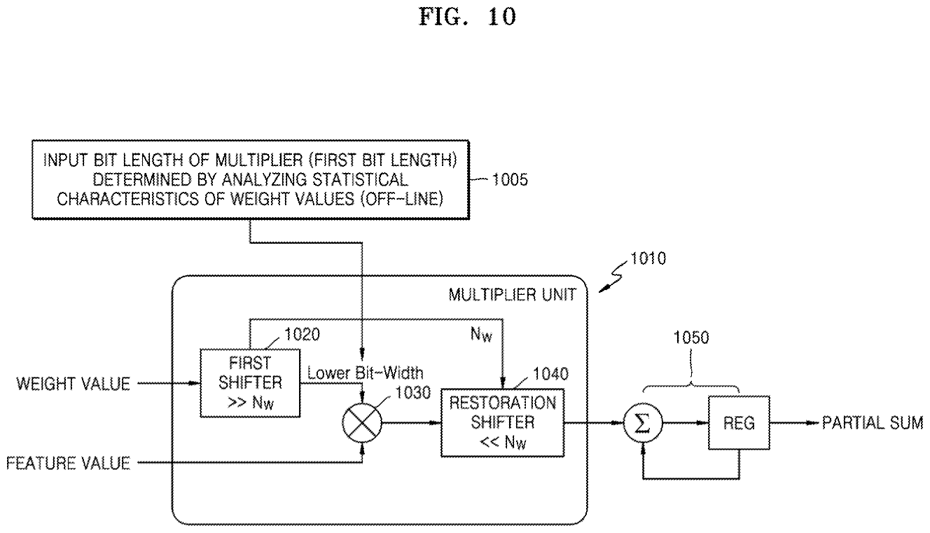

FIG. 10 is a diagram referenced to describe a fourth type MAC unit among a plurality of types of MAC units for performing MAC operations between weight values and feature values.

Unlike the above, an input feature map and a weight kernel according to an embodiment may be pieces of data that have not been transformed to the Winograd domain. In this case, bit lengths of a feature value included in the input feature map and a weight value included in the weight kernel may be less than bit lengths of a feature value transformed to the Winograd domain and a weight value transformed to the Winograd domain. Therefore, an operation of reducing the bit lengths of the feature value or weight value may not be needed.

In the description with respect to FIG. 10, a fourth type MAC unit, which is one of a plurality of types of MAC units that may be included in a computation unit, is described as a reference. One fourth type MAC unit may output a partial sum by performing a MAC operation between a weight value group and a feature value group.

Referring to FIG. 10, the fourth type MAC unit may include a plurality of multiplier units and an accumulator 1050 that accumulates and adds outputs respectively from the plurality of multiplier units. Hereinafter, for convenience of description, the multiplier unit 1010 that is one of the plurality of multiplier units is described as a reference.

According to an embodiment, the multiplier unit 1010 may include a first shifter 1020, a multiplier 1030, and a restoration shifter 1040.

According to an embodiment, the first shifter 1020 may receive a first fixed-point number representing a weight value to perform a right shift operation by using the first shifting method.

When a bit length of the received first fixed-point number does not exceed a preset first bit length, the first shifter 1020 may bypass the first fixed-point number. Also, when the bit length of the received first fixed-point number exceeds the preset first bit length, the first shifter 1020 may reduce the bit length by shifting the first fixed-point number to the right by a bit length N_{W} in excess of the first bit length. In this case, the first bit length may be a value determined by a statistical characteristics analyzer based on a result of analyzing statistical characteristics of weight values off-line. The statistical characteristics analyzer 1005 may determine the first bit length that is a bit length input to the multiplier 1030.

According to an embodiment, the multiplier 1030 may receive a value output from the first shifter 1020 and a non-shifted feature value to perform a multiplication operation therebetween.

According to an embodiment, the restoration shifter 1040 may receive a multiplication operation result output from the multiplier 1030 to perform a left shift operation for restoring a bit length.

According to an embodiment, the accumulator 1050 may accumulate and add values output from the plurality of multiplier units included in the fourth type MAC unit. The accumulator 1050 may include an adder and a register.

FIG. 11 is a diagram for explaining a method, performed by a statistical characteristics analyzer, of analyzing statistical characteristics of weight value groups and feature value groups, according to an embodiment.

In FIG. 11, the statistical characteristics analyzer 1100 may have the same configuration as the statistical characteristics analyzer 380 of FIG. 3.

Referring to FIG. 11, the statistical characteristics analyzer 1100 may be located outside the electronic device 300 and independently perform a statistical analysis on a weight kernel and an input feature map off-line with respect to the electronic device 300. For example, the statistical characteristics analyzer 1100 may be an external hardware or software module for the electronic device 300. However, the present disclosure is not limited thereto, and the statistical characteristics analyzer 1100 may be a hardware or software module included in the electronic device 300.

According to an embodiment, the statistical characteristics analyzer 1100 may analyze statistical characteristics of weight kernels 1130 transformed to the Winograd domain and input feature maps 1140 transformed to the Winograd domain.

In operation S1110, the statistical characteristics analyzer 1100 may analyze maximum and minimum values for each of a plurality of feature value groups and each of a plurality of weight value groups.

Specifically, the statistical characteristics analyzer 1100 may calculate a frequency distribution for each of the plurality of feature value groups. For example, the statistical characteristics analyzer 1100 may create a histogram by calculating a frequency distribution for a first feature value group comprising of feature values at coordinates (1, 1) in matrices representing a plurality of transformed input feature maps 1140. The statistical characteristics analyzer 1110 may generate transformed input feature map statistical characteristics 1150 by calculating a frequency distribution of feature values and creating a histogram for each of the first to sixteenth feature value groups in the plurality of transformed input feature maps 1140.

In the same way, the statistical characteristics analyzer 1100 may generate transformed weight kernel statistical characteristics 1160 by calculating a frequency distribution and creating a histogram for each of the plurality of weight value groups.

According to an embodiment, the statistical characteristics analyzer 1100 may obtain, based on created histograms, maximum and minimum values for each of the plurality of feature value groups and each of the plurality of weight value groups.

In operation S1120, the statistical characteristics analyzer 1100 may calculate fixed-shift bit lengths N_{shift} for each of the plurality of feature value groups and each of the plurality of weight value groups. For example, the fixed-shift bit length N_{shift} may be calculated by using Equation 7.

$${N}_{shift} = [ {log}_{2} \frac{{2}^{( precision - 1 )} - 1}{max ( \vert max\_val \vert , \vert min\_val \vert )} ] \qquad [ Equation 7 ]$$

Here, max_val denotes a maximum value of weight values included in a weight value group, and min_val denotes a minimum value of the weight values in the weight value group. Alternatively, max_val denotes a maximum value of feature values included in a feature value group, and min_val denotes a minimum value of the feature values included in the feature value group.

Because statistical characteristics of each of the plurality of feature value groups and statistical characteristics of each of the plurality of weight value groups according to an embodiment are all different, fixed-shift bit lengths calculated for each of the feature value groups and each of the weight value groups may all be different.

In addition, when a neural network model is defined, weight values may be fixed and thus maximum and minimum values thereof may be already clear, while maximum and minimum values for an input feature map may not be clearly fixed because the input feature map is arbitrary data. In this case, a data set for calibration may be analyzed offline, threshold values corresponding to maximum and minimum values may be determined, and statistical characteristics of the feature values may be analyzed based on the determined threshold values.

A fixed-shift bit length calculated by the statistical characteristics analyzer 1100 according to an embodiment may be provided to the second type MAC unit as described with reference to FIGS. 8A and 8B and used to perform a shift operation by using the second shifting method.

In addition, the fixed-shift bit length calculated by the statistical characteristics analyzer 1100 may be provided to the third type MAC unit as described with reference to FIGS. 9A and 9B and used to perform a shift operation by using the second shifting method.

While the embodiments have been described with reference to limited examples and figures, it will be understood by those of ordinary skill in the art that various modifications and changes in form and details may be made from the above descriptions. For example, adequate effects may be achieved even when the aforementioned components such as computer systems or modules are coupled or combined in different forms and modes than those described above or are replaced or supplemented by other components or their equivalents.

1. An electronic device, comprising:
an input feature map transformer configured to transform an input feature map (IFM) to a Winograd domain;
a weight kernel transformer configured to transform a weight kernel to the Winograd domain;
a transformation data processor configured to:
map, a plurality of types of multiply-accumulate (MAC) units included in a computation unit, to a plurality of feature groups created by grouping feature values in a plurality of channels of the transformed input feature map and a plurality of weight value groups created by grouping weight values in a plurality of channels of the transformed weight kernel, the plurality of types of MAC units being configured to perform a MAC operation between a weight value group of the plurality of weight value groups and a feature value group of the plurality of feature groups;
a computation data processor configured to collect MAC operation results from the computation unit; and
an inverse transformer configured to perform an inverse Winograd transform on a result output according to the collected MAC operation results from the computation data processor to thereby generate an output feature map (OFM) useable for performing a convolution operation.

2. The electronic device of claim 1, wherein
the computation unit comprises:
at least one type of MAC unit from among a first type MAC unit, a second type MAC unit, and a third type MAC unit included in the plurality of types of MAC units, and
the transformation data processor is configured to:
map the plurality of feature value groups and the plurality of weight value groups to the at least one type of MAC unit from among the first type MAC unit, the second type MAC unit, and the third type MAC unit included in the plurality of types of MAC units.

3. The electronic device of claim 2, wherein the transformation data processor is configured to map, based on a pre-generated mapping table, the plurality of feature value groups and the plurality of weight value groups to the at least one type of MAC unit from among the first type MAC unit, the second type MAC unit, and the third type MAC unit included in the plurality of types of MAC units.

4. The electronic device of claim 3, wherein
the first type MAC unit comprises:
a plurality of multiplier units; and
an accumulator configured to accumulate and add outputs respectively from the plurality of multiplier units, and
each of the plurality of multiplier units comprises:
a first shifter configured to receive a first fixed-point number and perform a right shift operation;
a second shifter configured to receive a second fixed-point number and perform a right shift operation;
a multiplier configured to receive an output of the first shifter and an output of the second shifter and perform a multiplication operation between the output of the first shifter and the output of the second shifter; and
a restoration shifter configured to receive an output of the multiplier and restore a bit length by performing a left shift operation on the output of the multiplier.

5. The electronic device of claim 4, wherein
the first shifter included in each of the plurality of multiplier units is configured to:
when a bit length of the first fixed-point number exceeds a preset first bit length, reduce the bit length of the first fixed-point number by shifting the first fixed-point number to the right by a bit length in excess of the preset first bit length,
the second shifter included in each of the plurality of multiplier units is configured to:
when a bit length of the second fixed-point number exceeds a preset second bit length, reduce the bit length of the second fixed-point number by shifting the second fixed-point number to the right by a bit length in excess of the preset second bit length, and
the restoration shifter included in each of the plurality of multiplier units is configured to:
restore the bit length of the first fixed-point number by shifting the output of the multiplier to the left by a sum of the bit length of the first fixed-point number by which the first shifter shifts the first fixed-point number to the right and the bit length of the second fixed-point number by which the second shifter shifts the second fixed-point number to the right.

6. The electronic device of claim 5, wherein the first fixed-point number received by the first shifter and the second fixed-point number received by the second shifter are input by exchanging, based on a value of the first fixed-point number, the first bit length, a value of the second fixed-point number, and the second bit length, the value of the first fixed-point number and the value of the second fixed-point number.

7. The electronic device of claim 3, wherein
the second type MAC unit comprises:
a plurality of multiplier units;
an accumulator configured to accumulate and add outputs respectively from the plurality of multiplier units; and
a second restoration shifter configured to receive an output of the accumulator and restore a bit length by performing a left shift operation on the output of the accumulator, and
each of the plurality of multiplier units comprises:
a first shifter configured to receive a first fixed-point number and perform a right shift operation;
a second shifter configured to receive a second fixed-point number and perform a right shift operation;
a multiplier configured to receive an output of the first shifter and an output of the second shifter and perform a multiplication operation between the output of the first shifter and the output of the second shifter; and
a first restoration shifter configured to receive an output of the multiplier and increase a bit length by performing a left shift operation on the output of the multiplier.

8. The electronic device of claim 7, wherein
the first shifter included in each of the plurality of multiplier units is configured to:
reduce a bit length of the first fixed-point number by shifting the first fixed-point number to the right by a preset first bit length,
the second shifter included in each of the plurality of multiplier units is configured to:
when a bit length of the second fixed-point number exceeds a preset second bit length, reduce the bit length of the second fixed-point number by shifting the second fixed-point number to the right by a bit length in excess of the preset second bit length,
the first restoration shifter included in each of the plurality of multiplier units is configured to:
increase the bit length of the second fixed-point number by shifting the output of the multiplier to the left by the bit length of the second fixed-point number by which the second shifter shifts the second fixed-point number to the right, and
the second restoration shifter is configured to:
restore the bit length of the first fixed-point number by shifting the output of the accumulator to the left by the preset first bit length.

9. The electronic device of claim 8, wherein the preset first bit length is determined for each of the plurality of weight value groups, based on a maximum value and a minimum value of weight values included in each of the plurality of weight value groups.

10. The electronic device of claim 3, wherein
the third type MAC unit comprises:
a plurality of multiplier units;
an accumulator configured to accumulate and add outputs respectively from the plurality of multiplier units; and
a restoration shifter configured to receive an output of the accumulator and restore a bit length by performing a left shift operation, and
each of the plurality of multiplier units comprises:
a first shifter configured to receive a first fixed-point number and perform a right shift operation;
a second shifter configured to receive a second fixed-point number and perform a right shift operation; and
a multiplier configured to receive an output of the first shifter and an output of the second shifter and perform a multiplication operation between the output of the first shifter and the output of the second shifter.

11. The electronic device of claim 10, wherein
the first shifter included in each of the plurality of multiplier units is configured to:
reduce a bit length of the first fixed-point number by shifting the first fixed-point number to the right by a preset first bit length,
the second shifter included in each of the plurality of multiplier units is configured to:
reduce a bit length of the second fixed-point number by shifting the second fixed-point number to the right by a preset second bit length, and
the restoration shifter is configured to:
restore the bit length by shifting the output of the accumulator to the left by a sum of the first bit length and the second bit length.

12. The electronic device of claim 11, wherein
the preset first bit length is determined for each of the plurality of weight value groups, based on a maximum value and a minimum value of weight values included in each of the plurality of weight value groups, and
the preset second bit length is determined for each of the plurality of feature value groups, based on a maximum value and a minimum value of feature values included in each of the plurality of feature value groups.

13. The electronic device of claim 11, wherein
the preset first bit length is determined for each of the plurality of weight value groups, based on a preset maximum threshold and a preset minimum threshold of weight values included in each of the plurality of weight value groups, and
the preset second bit length is determined for each of the plurality of feature value groups, based on a maximum value and a minimum value of feature values included in each of the plurality of feature value groups.

14. An operation method of an electronic device, comprising:
transforming an input feature map (IFM) to a Winograd domain;
transforming a weight kernel to the Winograd domain;
creating a plurality of feature value groups by grouping feature values at same coordinates in a plurality of channels of the transformed input feature map;
creating a plurality of weight value groups by grouping weight values at same coordinates in a plurality of channels of the transformed weight kernel;
mapping the plurality of feature value groups and the plurality of weight value groups to a plurality of types of multiply-accumulate (MAC) units included in the electronic device;
outputting a MAC operation value by performing, a MAC operation, for the plurality of feature value groups with the plurality of weight value groups, respectively;
generating a transformed output feature map by collecting MAC operation results according to the outputting of the output MAC operation value; and
performing an inverse Winograd transform on the generated transformed output feature map to thereby generate an output feature map (OFM) useable for performing a convolution operation.

15. A non-transitory computer-readable recording medium having recorded thereon a program to execute a method by an electronic device, the method comprising:
transforming an input feature map (IFM) to a Winograd domain;
transforming a weight kernel to the Winograd domain;
grouping feature values at same coordinates in a plurality of channels of the transformed input feature map to create a plurality of feature value groups;
grouping weight values at same coordinates in a plurality of channels of the transformed weight kernel to create a plurality of weight value groups;
mapping the plurality of feature value groups and the plurality of weight value groups to a plurality of types of multiply-accumulate (MAC) units included in the electronic device;
outputting a MAC operation value by performing, a MAC operation, for the plurality of feature value groups, with the plurality of weight value groups, respectively;
generating a transformed output feature map by collecting MAC operation results according to the outputting of the output MAC operation value; and
performing an inverse Winograd transform on the generated transformed output feature map to thereby generate an output feature map (OFM) useable for performing a convolution operation.
